(19) United States
(12) Patent Application Publication
(10) Pub. No.: US 2016/0059200 A1
(43) Pub. Date: Mar. 3, 2016

(54) MULTIPLE HEAT-TRANSFER MEDIA

(71) Applicant: INVISTA NORTH AMERICA, Wilmington, DE (US)

(72) Inventors: Thomas A. MICKA, McKinleyville, CA (US); Charles R. KELMAN, Sr., Hixson, TN (US); John P. POINSATTE, Hixson, TN (US)

(73) Assignee: INVISTA NORTH AMERICA S.A R.L., WILMINGTON, DE (US)

(21) Appl. No.: 14/786,672

(22) PCT Filed: Apr. 15, 2014
(86) PCT No.: PCT/US14/34081

§ 371 Date: Oct. 23, 2015

Related U.S. Application Data
(60) Provisional application No. 61/817,989, filed on May 1, 2013.

(51) Int. Cl. B01J 19/00; F28F 23/00; C09K 5/10; C08G 69/28

(52) U.S. Cl. CPC B01J 19/0013; C08G 69/28; F28F 23/00; C09K 5/10; B01J 2219/00074

(57) ABSTRACT

The present invention relates to methods, systems, and apparatus for making polyamides having at least two heat-transfer media. The method includes heating a first flowable heat-transfer medium, to provide a heated first flowable heat-transfer medium. The method includes transferring heat from the heated first flowable heat-transfer medium to a second flowable heat-transfer medium, to provide a heated second flowable heat-transfer medium. The method also includes transferring heat from the heated second flowable heat-transfer medium to at least one polyamide-containing component of a polyamide synthesis system.

### CROSS-REFERENCE TO RELATED APPLICATION

This application claims the benefit of priority to U.S. Provisional Patent Application Ser. No. 61/817,989, filed May 1, 2013, the disclosure of which is incorporated herein in its entirety by reference.

### BACKGROUND OF THE INVENTION

Polyamides have useful properties such as extreme durability and strength that makes them useful in a variety of settings. Polyamides such as nylons, aramids, and sodium poly(aspartate) are commonly used in, for example, carpet, airbags, machine parts, apparel, ropes, and hoses. Nylon-6,6, a silky thermoplastic material, is one of the most commonly used polyamides. Nylon-6,6's long molecular chains and dense structure qualifies it as a premium nylon fiber, which exhibits high mechanical strength, rigidity, and stability under heat.

Polyamides are commercially synthesized in large-scale production facilities. For example, nylon-6,6 can be synthesized by allowing hexamethylenediamine and adipic acid to undergo a condensation reaction, forming amide linkages and releasing water. In a series of components including either an autoclave or a reactor, a flasher, and a finisher, heat is applied to the reaction mixture and water is gradually removed to drive the equilibrium toward the polyamide, until the polymers reach the desired range of lengths. Then, the molten nylon-6,6 is extruded into pellets which can be spun into fibers or processed into other shapes. Large amounts of heating are required throughout the production facility to cause the condensation reaction to occur and to remove water from the reaction mixture. Typically, a central heating facility heats a single heating loop filled with volatile heat-transfer medium to vaporize the medium, which is then circulated throughout the plant to the various components requiring heating.

In methods and apparatuses for polyamide synthesis, there are safety risks associated with the use of large quantities of volatile materials as heat-transfer media, and there are problems such as losses of efficiency and inconveniences associated with the use of single plant-wide heating loops for the heating of multiple components of the plant. As explained herein, the present invention can provide solutions to these problems.

### SUMMARY OF THE INVENTION

The present invention can provide a method of making a polyamide. The method can include heating a first flowable heat-transfer medium, to provide a heated first flowable heat-transfer medium. The method can include transferring heat from the heated first flowable heat-transfer medium to a second flowable heat-transfer medium, to provide a heated second flowable heat-transfer medium. The method can also include transferring heat from the heated second flowable heat-transfer medium to at least one polyamide-containing component of a polyamide synthesis system.

The present invention can provide a method of making nylon-6,6. The method can include heating a first flowable heat-transfer medium including a terphenyl, to provide a heated first flowable heat-transfer medium. The method can include transferring heat from the heated first flowable heat-transfer medium to a second flowable heat-transfer medium including diphenyl oxide and biphenyl, to provide a heated second flowable heat-transfer medium and a used first flowable heat-transfer medium. The first flowable heat-transfer medium, the heated first flowable heat-transfer medium, and the used first flowable heat-transfer medium can be disposed in a first heating loop. During the heating of the first flowable heat-transfer medium and transferring of heat from the heated first flowable heat-transfer medium to the second flowable heat-transfer medium, the first flowable heat-transfer medium, the heated first flowable heat-transfer medium, and the used first flowable can be substantially liquid phase. The heat transferred to the first flowable heat-transfer medium and the heat transferred from the first flowable heat-transfer medium can include substantially all sensible heat. During the transferring of heat from the heated first flowable heat-transfer medium to the second flowable heat-transfer medium, the second flowable heat-transfer medium can be substantially all vaporized. The method can include circulating the used first flowable heat-transfer medium back to the heating of the first flowable heat-transfer medium. The method can include transferring heat from the heated second flowable heat-transfer medium to at least one component of a nylon-6,6 synthesis system including a preheater, an evaporator, a polymerization reactor, a flasher, a finisher, or an autoclave, providing a used second flowable heat-transfer medium. The second flowable heat-transfer medium and the heated second flowable heat-transfer medium can be disposed in a second heating loop. The second flowable heat-transfer medium and the used second flowable heat-transfer medium can be substantially liquid phase. The heated second flowable heat-transfer medium can be substantially liquid phase. The heat transferred to the second flowable heat-transfer medium, and the heat transferred from the second flowable heat-transfer medium can include about 70-100% latent heat including heat of vaporization, and about 0-30% sensible heat. The method also can include controlling a pressure of the second heat-transfer loop to control a saturation temperature of the second flowable heat-transfer medium, wherein controlling the saturation temperature controls a temperature of the at least one polyamide-containing component of the polyamide synthesis system. The method can also include circulating the used second flowable heat-transfer medium back to the transferring of heat from the heated first flowable heat-transfer medium.

The present invention can provide a system for making a polyamide. The system can include a heater configured to heat a first flowable heat-transfer medium to provide a heated first flowable heat-transfer medium. The system can include a first heat exchanger configured to transfer heat from the heated first flowable heat-transfer medium to provide a heated second flowable heat-transfer medium. The system can also include a second heat exchanger configured to transfer heat from the heated second flowable heat-transfer medium to at least one polyamide-containing component of a polyamide synthesis system.

The present invention can provide an apparatus for making a polyamide. The apparatus can include a heater configured to heat a first flowable heat-transfer medium to provide a heated first flowable heat-transfer medium. The apparatus can include a first heat exchanger configured to transfer heat from the heated first flowable heat-transfer medium to provide a heated second flowable heat-transfer medium. The apparatus can also include a second heat exchanger configured to transfer heat from the heated second flowable heat-transfer medium to at least one polyamide-containing component of a polyamide synthesis system.

The present invention can provide an apparatus for making nylon-6,6. The apparatus can include a heater configured to heat a first flowable heat-transfer medium including a terphenyl, to provide a heated first flowable heat-transfer medium. The apparatus can include a first heat exchanger configured to transfer heat from the heated first flowable heat-transfer medium to a second flowable heat-transfer medium including diphenyl oxide and biphenyl, to provide a heated second flowable heat-transfer medium and a used first flowable heat-transfer medium, and to circulate the used first flowable heat-transfer medium back to the first heat exchanger. The first flowable heat-transfer medium, the heated first flowable heat-transfer medium, and the used first flowable heat-transfer medium can be disposed in a first heating loop. During the heating of the first flowable heat-transfer medium and transferring of heat from the heated first flowable heat-transfer medium to the second flowable heat-transfer medium, the first flowable heat-transfer medium, the heated first flowable heat-transfer medium, and the used first flowable heat-transfer medium are substantially liquid phase. The heat transferred to the first flowable heat-transfer medium and the heat transferred from the first flowable heat-transfer medium can include substantially all sensible heat. During the transferring of heat from the heated first flowable heat-transfer medium to the second flowable heat-transfer medium, the second flowable heat-transfer medium can be substantially all vaporized. The apparatus can include a second heat exchanger configured to transfer heat from the heated second flowable heat-transfer medium to at least one component of a nylon-6,6 synthesis system including a preheater, an evaporator, a polymerization reactor, a flasher, a finisher, or an autoclave, providing a used second flowable heat-transfer medium, and to circulate the used second flowable heat-transfer medium back to the transferring of heat from the heated first flowable heat-transfer medium. The second flowable heat-transfer medium and the heated second flowable heat-transfer medium can be disposed in a second heating loop, which can be configured to control a pressure of the second heat-transfer loop to control a saturation temperature of the second flowable heat-transfer medium, wherein controlling the saturation temperature controls a temperature of the at least one polyamide-containing component of the polyamide synthesis system. The second flowable heat-transfer medium and the used second flowable heat-transfer medium can each be a substantially liquid phase, the heated second flowable heat-transfer medium can be substantially liquid phase. The heat transferred to the second flowable heat-transfer medium, and the heat transferred from the second flowable heat-transfer medium, can include about 70-100% latent heat including heat of vaporization, and about 0-30% sensible heat.

The present invention can provide advantages over other methods, systems, and apparatus for making polyamides, at least some of which are unexpected. If a primary heating loop containing volatile (e.g., gaseous) heat-transfer media has a leak, the leaking material can diffuse throughout the space around the leak. If the volatile heat-transfer medium is flammable, the leak can cause an explosion or a fire risk throughout the space around the leak. In addition, the vaporous heat-transfer medium can pose a safety risk far beyond the immediate vicinity of the leak. If a leak occurs allowing polymer material to enter the primary heating loop, coke formation in furnaces used for heating the primary heating loop can create a significant fire risk. Primary heating loops containing non-volatile heat-transfer media (e.g., liquid) can be safer than heating loops containing volatile heat-transfer media, and can enable a plant to have a much smaller inventory of dangerous volatile heat-transfer media. If a leak occurs, the non-volatile leaking material generally moves to the floor around the leak, confining any fire and safety risk predominately to the area near to and under the leak, and having a lower explosion risk than a volatile material. If a leak occurs allowing polymer material to enter the primary heating loop, the fire risk from coked tubes in heaters can be significantly less.

A single loop or a secondary heating loop containing non-volatile material can experience localized high temperatures due to the use of sensible heat to transfer the heat from the heating loop to the particular component, which can make controlling the heating of that component difficult. Disadvantages associated with using non-volatile materials in heating loops used to heat components of the facility can be avoided by using various embodiments of the present invention: using volatile materials (e.g., at the temperatures and pressures used, the material becomes substantially vaporized upon heating and condenses after cooling) in one or more secondary heating loops each for heating one or more components, while using a primary heating loop containing non-volatile heat-transfer medium (e.g., at the temperatures and pressures used, the material substantially remains a liquid upon heating and after cooling) to heat the secondary heating loops. The secondary loops can be used to heat the various components using predominantly latent heat (e.g., heat of vaporization) to transfer heat to the component, advantageously allowing easier temperature control while avoiding the use of large quantities of volatile material and avoiding the use of a single heating loop to heat all components.

Using a primary loop of lower volatility heat-transfer medium which heats a secondary loop of higher volatility heat-transfer medium for various components can make leaks in a heating loop for an individual component easier to fix. For example, if a leak occurs in a single heating loop having vaporous heat-transfer material therein being used to heat several components around a plant, the entire loop must be shut down to service the leak, or to extinguish a fire fed by the leak, causing large portions of the plant to go off-line, which can be inconvenient and expensive. However, by having the vaporous heat-transfer material contained in a secondary loop specific to one or more particular components, a leak in the secondary loop only requires servicing of that loop, while the rest of the plant can continue to operate normally. In various examples, by using non-volatile heat-transfer medium in a primary loop and by avoiding the use of large quantities of volatile flammable heat-transfer media, the safety risks associated with the use of volatile heat-transfer materials are decreased. For example, a leak in a large primary loop containing the liquid phase heat-transfer material can be less hazardous than a leak in a large loop containing vaporous heat-transfer material.

Use of a single loop of heat-transfer material can limit the temperature of materials available for heat transfer to a narrow range of temperatures. Use of a secondary loop with volatile heat-transfer media therein for an individual component can allow facile control of the temperature of the heat-transfer medium. The primary loop can be used to vaporize the volatile material in the secondary loop, which can be allowed to condense to transfer heat to an individual component of the plant. The pressure within a secondary loop can be adjusted to control the saturation temperature of the heat-transfer medium, thereby precisely controlling the temperature at which the volatile heat-transfer medium in the secondary loop vaporizes and condenses, providing a greater control over the temperature of the plant component than other methods, systems, and apparatus for making a polyamide. When multiple secondary loops are employed, each containing volatile heat-transfer media, the saturation temperature of the heat-transfer media in each secondary loop can be easily controlled.

Use of a single loop with a volatile heat-transfer material (vapor/gas phase) can involve initially heating the heat-transfer material well above the temperature used by each component of the plant. This can result in the heat-transfer material being superheated (e.g., brought to a temperature above the saturation temperature for the given pressure). If stringent temperature control is required, additional complexity is needed to remove the superheat in order to achieve temperature uniformity. In various embodiments, a secondary loop can allow the use of heat transfer material in the secondary loop that is at or very near the saturation temperature, thereby achieving a high degree of temperature uniformity with less complex equipment. In various embodiments, use of a saturated vapor versus superheated vapor can be more effective for heat transfer. If the vapor is significantly superheated, the vapor is first be cooled to saturation temperature prior to condensation occurring. Superheated vapor has a much lower heat transfer coefficient than condensing vapor. In various embodiments, the use heat-transfer material as a saturated vapor having less superheat than other methods or apparatuses allows for more heat transfer for a given surface area or allows for less surface area to achieve the same amount of heat transfer. In various embodiments, use of a low volatility liquid in the primary heating loop with a condensing vapor in the secondary loop can allow for lower heat transfer area (process vessel size), such as in portions of the process with high heat demand.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a system or apparatus, in accordance with various embodiments.

FIG. 2 illustrates a system or apparatus, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “solvent” as used herein refers to a liquid that can dissolve a solid, liquid, or gas. Nonlimiting examples of solvents are silicones, organic compounds, water, alcohols, ionic liquids, and supercritical fluids.

The term “standard temperature and pressure” as used herein refers to 0° C. and 100 KPa.

The term “polymer” as used herein can include a copolymer.

The term “heat exchanger” as used herein refers to an apparatus for transferring heat from one medium to another. The media can be separated by a solid wall. Examples of heat exchangers include a shell and tube exchanger, plate heat exchanger, plate and shell heat exchanger, adiabatic wheel heat exchanger, plate fin heat exchanger, pillow plate heat exchanger, fluid heat exchanger, waste hear recovery unit, dynamic scraped surface heat exchanger, and phase-change heat exchanger.

The term “sensible heat” as used herein refers to heat exchanged by a body or thermodynamic system wherein the effect of the exchange is substantially a change in temperature of the body or system, with little to no phase change.

The term “latent heat” as used herein refers to heat exchanged by a body or thermodynamic system wherein the effect of the exchange is substantially a change in phase of the body or system, with little to no temperature change.

The term “relative viscosity” (RV) as used herein refers to the ratio of solution and solvent viscosities measured in a capillary viscometer at 25° C. In one example, RV by ASTM D789-06 is the ratio of viscosity (in centipoises) at 25° C. of 8.4% by weight solution of the polyamide in 90% formic acid (90% by weight formic acid and 10% by weight water) to the viscosity (in centipoises) at 25° C. of 90% formic acid alone.

The term “saturation temperature” as used herein refers to the temperature at a particular pressure (e.g., the saturation pressure at that temperature) at which a liquid boils into its vapor phase and the temperature at which a vapor begins to condense into its liquid phase. At the saturation temperature for a material at a particular pressure, as the temperature is decreased or the pressure is increased, the material will condense. At the saturation temperature for a material at a particular pressure, as the temperature is increased or the pressure is decreased, the material will boil into its vapor phase.

The present invention relates to methods, systems, and apparatus for making polyamides having at least two heat-transfer media.

Method of Making a Polyamide.

The method can include heating a first flowable heat-transfer medium, to provide a heated first flowable heat-transfer medium. The heating can be conducted in any suitable manner. The heating can be conducted in a heat-exchanger, such as any suitable heat-exchanger. The first flowable heat-transfer medium can be located in a heating loop. The first flowable heat-transfer medium can be heated in a powerhouse or central heating area in the facility and can be used to transfer heat throughout the facility from a primary heating loop to one or more secondary heating loops before returning to the powerhouse for reheating. A secondary heating loop can be used to heat one or more individual components of the facility. The first flowable heat-transfer medium can be non-volatile, such that the first flowable heat-transfer medium can substantially be in a liquid phase before and after the heating.

The primary heating loop and the one or more secondary heating loops can have any suitable volume with respect to one another. The primary heating loop can have a larger volume than the secondary heating loop. The primary heating loop can have about the same volume or have a smaller volume than the secondary heating loop. The primary heating loop can have about 0.000,1%-1,000,000% of the volume of the secondary heating loop, or about 0.1% to about 1,000%, about 1% to about 100%, about 100% to 1,000,000%, about 1,000% to 1,000,000%, or about 0.000,1% or less, or about 0.001%, 0.01%, 0.1%, 1%, 5%, 10%, 25%, 50%, 75%, 100%, 125%, 150%, 175%, 200%, 300%, 400%, 500%, 750%, 1000%, 1500%, 2000%, 3000%, 4000%, 5000%, 10,000%, 20,000%, 50,000%, 100,000%, about 500,000%, or about 1,000,000% or more of the volume of the secondary heating loop. The first flowable heat-transfer medium and the heated first flowable heat-transfer medium can have any suitable mass ratio with the second flowable heat-transfer medium and the heated second flowable heat-transfer medium. For example, the ratio of the combination of the mass of the first flowable heat-transfer medium and the heated first flowable heat-transfer medium to the combination of the mass of the second flowable heat-transfer medium and the heated second flowable heat-transfer medium can be about 0.000,000,1:1 to about 10,000,000:1, about 100:1 to about 100:1, about 0.000,000,1:1 or less, or about 0.000,1:1, 0.001:1, 0.01:1, 0.1:1, 1:1, 5:1, 10:1, 25:1, 50:1, 75:1, 100:1, 125:1, 150:1, 175:1, 200:1, 300:1, 400:1, 500:1, 750:1, 1000:1, 1500:1, 2000:1, 3000:1, 4000:1, 5000:1, 10,000:1, 20,000:1, 50,000:1, 100,000:1, 500,000:1, about 1,000,000:1, or about 10,000,000:1 or more.

The method can include transferring heat from the heated first flowable heat-transfer medium to a second flowable heat-transfer medium, to provide a heated second flowable heat-transfer medium. The heating can be conducted in any suitable fashion. The heating can be conducted in a heat-exchanger, such as any suitable heat exchanger. The second flowable heat-transfer medium can be sufficiently volatile such that it can be heated to a substantially gaseous phase by the first flowable heat-transfer medium, and such that it can condense to a substantially liquid phase during the transfer of heat from the heated second flowable heat-transfer medium to the one or more components of the facility.

The first flowable heat-transfer medium can remain a liquid through the heating and transferring of heat, while the second flowable heat-transfer medium can become vaporized as it is heated and can condense as heat is transferred from it. At standard temperature and pressure, the first flowable heat-transfer medium can have a lower vapor pressure than the second flowable heat-transfer medium; or, the first flowable heat-transfer medium can have a higher vapor pressure than the second flowable heat-transfer medium. The pressure of the second flowable heat-transfer medium can be controlled such that it vaporizes and condenses at a desired temperature. Since the first flowable heat-transfer medium can remain a liquid after being heated, and the second flowable heat-transfer medium can become substantially vaporized after the heating, the heated second flowable heat-transfer medium can have a higher vapor pressure than the heated first flowable heat-transfer medium.

The first flowable heat-transfer medium and the second flowable heat-transfer medium can both be flammable organic materials, or can both include flammable organic components. Vaporous and high vapor pressure flammable organic materials typically are associated with a greater risk of fire and combustion than liquid flammable organic compounds having a lower vapor pressure. The heated second flowable heat-transfer medium can be at least one of more flammable and more combustible than the heated first flowable heat-transfer medium.

The method can also include transferring heat from the heated second flowable heat-transfer medium to at least one polyamide-containing component of a polyamide synthesis system. The polyamide can be any suitable polyamide, such as nylon 6, nylon 7, nylon 11, nylon 12, nylon 6,6, nylon 6,9; nylon 6,10, nylon 6,12, partially aromatic polyamides (e.g., high temperature nylons), or copolymers thereof. The transferring of heat can be conducted in any suitable fashion. The transferring of heat can be conducted in a heat-exchanger, such as any suitable heat exchanger. The heat can be transferred from the heated second flowable heat-transfer medium to a single plant component, or to multiple plant components. For example, heat can be transferred from the heated second flowable heat-transfer medium to at least one of a preheater, an evaporator, a polymerization reactor, a flasher, a finisher, and an autoclave. The preheater can be any suitable preheater and can be associated with any suitable component of the facility, such as a preheater for at least one of an evaporator, a polymerization reactor, a flasher, a finisher, and an autoclave. The temperature of the individual component can be brought to any suitable temperature or range of temperature by the heated second flowable heat-transfer medium. For example, sufficient heat can be transferred to the evaporator to raise the temperature of the reaction mixture therein to any suitable temperature, such as a temperature of about 100-230° C., or 100-150° C., or about 100° C. or less, or about 110° C., 120, 130, 140, 150, 160, 170, 180, 190, 200, 210, 220° C., or about 230° C. or more. For example, sufficient heat can be transferred to the reactor to raise the temperature of the reaction mixture therein to any suitable temperature, such as a temperature of about 150-300° C., or about 200-250° C., or about 215-245° C., or about 150° C. or less, or about 160° C., 170, 180, 190, 200, 210, 215, 220, 225, 230, 235, 240, 245, 250, 260, 270, 280, 290° C., or about 300° C. or more. For example, sufficient heat can be transferred to the flasher to raise the temperature of the reaction mixture therein to any suitable temperature, such as a temperature of about 150-400° C., or about 250-350° C., or about 250-310° C., or about 200° C. or less, or about 210° C., 220, 230, 240, 250, 260, 265, 270, 275, 280, 285, 290, 295, 300, 305, 310, 320, 330, 340° C., or about 350° C. or more. For example, sufficient heat can be transferred to the finisher to raise the temperature of the reaction mixture therein to any suitable temperature, such as a temperature of about 150-400° C., or about 250-350° C., or about 250-310° C., or about 200° C. or less, or about 210° C., 220, 230, 240, 250, 260, 265, 270, 275, 280, 285, 290, 295, 300, 305, 310, 320, 330, 340° C., or about 350° C. or more.

Transferring heat from the heated second flowable heat-transfer medium to the at least one component of the polyamide synthesis system can include maintaining the temperature of the at least one component of the polyamide synthesis system at any suitable temperature, such as about 100° C. to about 400° C., 150° C. to 350° C., 150° C. to 250° C., 250° C. to 350° C., 200° C. to 300° C., or about 210° C. to 260° C., or about 100° C., 110, 120, 130, 140, 150, 160, 170, 180, 190, 200, 210, 220, 230, 240, 250, 260, 270, 280, 290, 300, 310, 320, 330, 340, 350, 360, 370, 380, 390° C., or about 400° C. or more. Transferring heat from the heated second flowable heat-transfer medium to the at least one component of the polyamide synthesis system can include maintaining the temperature of a polyamide mixture in a reactor at any suitable temperature, such as about 210° C. to 260° C., or about 218° C. to about 250° C., or about 100° C. or less, or about 110° C., 120, 130, 140, 150, 160, 170, 180, 190, 200, 205, 210, 215, 220, 225, 230, 235, 240, 245, 250, 255, 260, 265, 270, 280, 290, 300, 310, 320, 330, 340, 350, 360, 370, 380, 390° C., or about 400° C. or more.

In some examples, the heated second flowable heat-transfer medium can be used for other purposes in addition to or as an alternative to transferring heat to at least one component of the polyamide synthesis system. For example, the second flowable heat-transfer medium can be water, and the heated second flowable heat-transfer medium can be steam, which can be used in various parts of the plant where steam is needed, avoiding the expense of fuel-fired steam boilers.

### System and Apparatus for Making a Polyamide.

The present invention can provide a system for making a polyamide. The system can be any suitable system that can carry out the method described herein. The system includes a heater. The heater can be any suitable heater. The heater can be configured to heat a first flowable heat-transfer medium to provide a heated first flowable heat-transfer medium.

The system can include a first heat exchanger. The first heat exchanger can be any suitable heat exchanger. The first heat exchanger can be configured to transfer heat from the heated first flowable heat-transfer medium to provide a heated second flowable heat-transfer medium.

The system can include a second heat exchanger. The second heat exchanger can be any suitable heat exchanger. The second heat exchanger can be configured to transfer heat from the heated second flowable heat-transfer medium to at least one polyamide-containing component of a polyamide synthesis system.

The present invention can provide an apparatus for making a polyamide. The system can be any suitable apparatus that can carry out the method described herein. The apparatus can include a heater. The heater can be any suitable heater. The heater can be configured to heat a first flowable heat-transfer medium to provide a heated first flowable heat-transfer medium.

The apparatus can include a first heat exchanger. The first heat exchanger can be any suitable heat exchanger. The first heat exchanger can be configured to transfer heat from the heated first flowable heat-transfer medium to provide a heated second flowable heat-transfer medium.

The apparatus can include a second heat exchanger. The second heat exchanger can be any suitable heat exchanger. The second heat exchanger can be configured to transfer heat from the heated second flowable heat-transfer medium to at least one polyamide-containing component of a polyamide synthesis system.

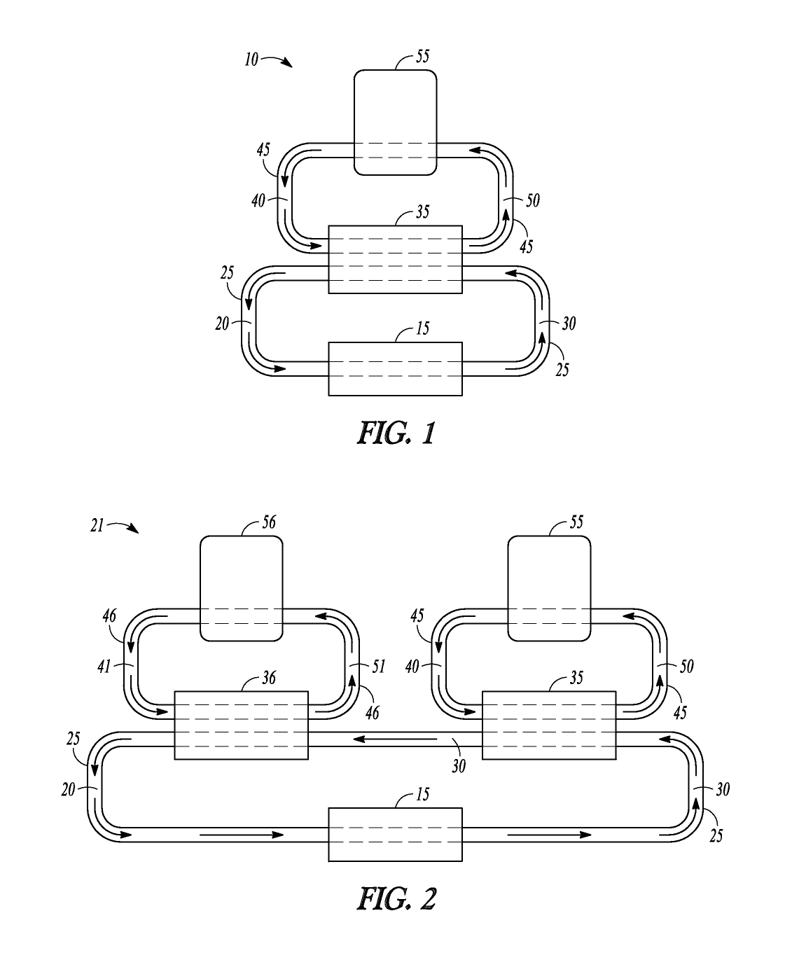

FIG. 1 illustrates an embodiment of a system or apparatus 10 for making a polyamide. The system or apparatus can include a heater 15. The heater heats a first flowable heat-transfer medium 20, disposed in primary heating loop 25, to provide a heated first flowable heat-transfer medium 30. The system or apparatus can include a first heat exchanger 35. The first heat exchanger 35 transfers heat from the heated first flowable heat-transfer medium 30 to a second flowable heat-transfer medium 40, disposed in secondary heating loop 45, to provide a heated second flowable heat-transfer medium 50. The first flowable heat-transfer medium 20 (e.g., used first flowable heat-transfer medium) is transferred back to the heater 15 for reheating. The system or apparatus can include a second heat exchanger 55. The second heat exchanger 55 transfers heat from the heated second flowable heat-transfer medium 50 to at least one polyamide-containing component of a polyamide synthesis system, which can be integrated with second heat exchanger 55. The second flowable heat-transfer medium 40 (e.g., used second flowable heat-transfer medium) is transferred back to the second heat exchanger 35 for reheating. The system or apparatus can use any suitable means to convey heat transfer medium from one location to another, such as pumping or convection.

FIG. 2 illustrates an embodiment of a system or apparatus 21 for making a polyamide. The system or apparatus can include a heater 15. The heater heats a first flowable heat-transfer medium 20, disposed in primary heating loop 25, to provide a heated first flowable heat-transfer medium 30. The system or apparatus can include a first heat exchanger 35. The first heat exchanger 35 transfers heat from the heated first flowable heat-transfer medium 30 to a second flowable heat-transfer medium 40, disposed in secondary heating loop 45, to provide a heated second flowable heat-transfer medium 50. The system or apparatus can include a second heat exchanger 55. The second heat exchanger 55 transfers heat from the heated second flowable heat-transfer medium 50 to at least one polyamide-containing component of a polyamide synthesis system, which can be integrated with second heat exchanger 55. The second flowable heat-transfer medium (e.g., used second flowable heat-transfer medium) is transferred back to the second heat exchanger for reheating. The heated first flowable heat-transfer medium 30 is transferred to a third heat exchanger 36. The third heat exchanger 36 transfers heat from the heated first flowable heat-transfer medium 30 to a second flowable heat-transfer medium 41, disposed in secondary heating loop 46, to provide a heated second flowable heat-transfer medium 51. The system or apparatus can include a fourth heat exchanger 56. The fourth heat exchanger 56 transfers heat from the heated second flowable heat-transfer medium 51 to at least one polyamide-containing component of a polyamide synthesis system, which can be integrated with fourth heat exchanger 56. The second flowable heat-transfer medium 41 (e.g., used second flowable heat-transfer medium) is transferred back to the third heat exchanger 36 for processing. The first flowable heat-transfer medium 20 (e.g., used first flowable heat-transfer medium) is transferred back to the heater 15 for reheating.

Although FIG. 2 illustrates an embodiment wherein the first heat exchanger 35 and third heat exchanger 36 are in series, such that third heat exchanger 36 receives heated first flowable heat transfer medium 30 after it has transferred heat to the second flowable heat-transfer medium 40, the present invention also encompasses parallel arrangements of the heat exchangers that exchange heat between the primary and secondary heating loops. For example in an embodiment, third heat exchanger 36 can draw heated first flowable heat transfer medium at a point in the first heating loop upstream of the return of the used first flowable heat transfer medium from heat exchanger 35, such that the third heat exchanger does not draw first flowable heat transfer medium that has already transferred some heat to the second flowable heat-transfer medium 40 in first heat exchanger 35.

### First Flowable Heat-Transfer Medium.

In the method, system, or apparatus, the first flowable heat-transfer medium can be any suitable flowable heat-transfer medium. The first flowable heat-transfer medium can include one or more organic compounds with characteristics making the first flowable heat-transfer medium suitable for use in the methods, systems, and apparatus described herein. The first flowable heat-transfer medium can be, for example, at least one of water, a polyethylene glycol, a polypropylene glycol, a mineral oil, a silicone oil, diphenyl oxide, biphenyl, an inorganic salt, a Therminol® brand heat-transfer fluid, and a Dowtherm™ brand heat-transfer fluid. The first flowable heat-transfer medium can be, for example, a Therminol® brand heat-transfer fluid, such as at least one of Therminol® VLT (e.g., methylcyclohexane, trimethylpentane), Therminol® D-12 (e.g., C₁₀₋₁₃ alkanes, e.g., iso-alkanes), Therminol® LT (e.g., diethylbenzene), Therminol® XP (e.g., white petroleum mineral oil), Therminol® 55 (e.g., C₁₄₋₃₀ alkylaryl compounds), Therminol® 59 (e.g., ethyl diphenyl ethane, diphenyl ethane, diethyl diphenyl ethane, ethylbenzene polymer), Therminol® 62 (e.g., diisopropyl biphenyl, triisopropyl biphenyl), Therminol® VP-3 (e.g., cyclohexylbenzene, bicyclohexyl), Therminol® 66 (e.g., terphenyls (ortho-terphenyl, meta-terphenyl, para-terphenyl), hydrogenated terphenyls, partially hydrogenated quaterphenyls, partially hydrogenated higher polyphenyls), Therminol® 72 (e.g., diphenyl ether, terphenyls, biphenyl, phenanthrene), Therminol® VP-1 (e.g., diphenyl ether, biphenyl), Therminol® FF (e.g., ethylenated benzene). The first flowable heat-transfer medium can include, for example, trimethylpentane, a C₁₀₋₁₃ alkane, a C₁₀₋₁₃ iso-alkane, a C₁₄₋₃₀ alkylaryl compound, a diethylbenzene, an ethylenated benzene, a cyclohexylbenzene, a C₁₄₋₃₀ alkyl benzene, white petroleum mineral oil, ethyl diphenyl ethane, diphenyl ethane, diethyl diphenyl ethane, diphenyl ether, diphenyl oxide, ethylbenzene polymer, biphenyl, diisopropyl biphenyl, triisopropyl biphenyl, methylcyclohexane, bicyclohexyl, a terphenyl, a hydrogenated terphenyl, a partially hydrogenated quaterphenyls, a partially hydrogenated higher polyphenyl, diphenyl ether, and phenanthrene, a diaryl compound, a triaryl compound, a diaryl ether, a triaryl ether, an alkylaryl compound, an alkylaryl compound, a diarylalkyl compound, or a combination thereof.

The first flowable heat-transfer medium can have any suitable temperature. For example, the first flowable heat-transfer medium can be about 20° C. to 400° C., or about 50° C. to 350° C., 100° C. to 300° C., 100° C. to 200° C., 200° C. to 250° C., or about 250° C. to 300° C., or about 20° C. or less, or about 30° C., 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390° C., or about 400° C. or more. The first flowable heat-transfer medium can have any suitable phase, such as gas phase, liquid phase, or any suitable combination thereof. For example, the first flowable heat-transfer medium can be about 60% or less, or about 70%, 80, 85, 90, 95, 96, 97, 98, or about 99% or more liquid phase, by weight. The first flowable heat-transfer medium can be substantially liquid phase.

The heated first flowable heat-transfer medium can have any suitable temperature. For example, the heated first flowable heat-transfer medium can be about 100° C. to 500° C., 100° C. to 400° C., 100° C. to 300° C., 100° C. to 200° C., 200° C. to 250° C., 250° C. to 300° C., 300° C. to 350° C., 350° C. to 400° C., 400° C. to 500° C., 280° C. to 400° C., or 330° C. to 350° C., or about 100° C. or less, or about 110° C., 120, 130, 140, 150, 160, 170, 180, 190, 200, 210, 220, 230, 240, 250, 260, 270, 280, 290, 300, 310, 320, 330, 340, 350, 360, 370, 380, 390° C., or about 400° C. or more. The heated first flowable heat-transfer medium can have any suitable phase, such as gas phase, liquid phase, or any suitable combination thereof. For example, the heated first flowable heat-transfer medium can be about 60% or less, or about 70%, 80, 85, 90, 95, 96, 97, 98, or about 99% or more liquid phase, by weight. The heated first flowable heat-transfer medium can be substantially liquid phase.

During the heating of the first flowable heat-transfer medium, the first flowable heat-transfer medium can substantially remain a liquid (e.g., substantially no vaporization of the first flowable heat-transfer medium occurs). During the heating of the first flowable heat-transfer medium, the heat transferred to the first flowable heat-transfer medium can include substantially all sensible heat. For example, during the heating of the first flowable heat-transfer medium, the heat transferred to the first flowable heat-transfer medium can include any suitable percentage of sensible heat, such as about 60% or less, or about 70%, 80, 85, 90, 95, 96, 97, 98, or about 99% or more sensible heat, with the remainder being latent heat (e.g., heat of vaporization).

During the transferring of heat from the heated first flowable heat-transfer medium to the second flowable heat-transfer medium, the heated first flowable heat-transfer medium can substantially remain a liquid. For example, no freezing of the first flowable heat-transfer medium occurs. During the transferring of heat from the heated first flowable heat-transfer medium to the second flowable heat-transfer medium, substantially no condensation of the heated first flowable heat-transfer medium occurs. For example, if the heated first flowable heat-transfer medium is substantially liquid phase, no condensation occurs, or only the minor gaseous phase component of the heated first flowable heat-transfer medium condenses. During the transferring of heat from the heated first flowable heat-transfer medium to the second flowable heat-transfer medium, the heat transferred from the heated first flowable heat-transfer medium can include substantially all sensible heat. For example, during the transferring of heat from the heated first flowable heat-transfer medium to the second flowable heat-transfer medium, the heat transferred from the heated first flowable heat-transfer medium can include any suitable percentage of sensible heat, such as about 60% or less, or about 70%, 80, 85, 90, 95, 96, 97, 98, or about 99% or more sensible heat, with the remainder being latent heat (e.g., heat of vaporization).

The first flowable heat-transfer medium and the heated first-flowable heat-transfer medium can both be disposed in a first heating loop. Transferring heat from the heated first flowable heat-transfer medium to the second flowable heat-transfer medium can provide a used first flowable heat-transfer medium. The method can include circulating the used first flowable heat-transfer medium back to the heating of the first flowable heat-transfer medium. The first heating loop can be a primary loop that circulates the first heat-transfer medium between a central heating location in the facility and one or more secondary loops containing the second flowable heat-transfer medium, or the first heating loop can be a primary loop that is used, for example, to heat less than all of the secondary loops containing the second flowable heat-transfer medium.

The method can include at least one of controlling the pressure of the first flowable heat-transfer medium and controlling the temperature of the heated first flowable heat-transfer medium. Controlling the pressure of the first flowable heat-transfer medium and controlling the pressure of the heated first flowable heat-transfer medium can include controlling a pressure in the first heating loop. The pressure can be controlled to be any suitable pressure, such as about 50 KPa to 1,000,000 KPa, 100 KPa to 500,000 KPa, or 500 KPa to 250,000 KPa, or about 50 KPa or less, or about 100 KPa, 500 KPa, 1 MPa, 2 MPa, 3, 4, 5, 6, 7, 8, 9, 10, 12.5, 15, 17.5, 20, 25, 30, 35, 40, 45, 50, 60, 70, 80, 90, 100, 125, 150, 175, 200 MPa, or about 250 MPa or more. In some examples the saturation temperature can be controlled to be any suitable temperature, such as about 100° C. to 500° C., 100° C. to 400° C., 100° C. to 300° C., 100° C. to 200° C., 200° C. to 250° C., 250° C. to 300° C., 300° C. to 350° C., 350° C. to 400° C., 400° C. to 500° C., 210° C. to 350° C., or 260° C. to 300° C., or about 100° C. or less, or about 110° C., 120, 130, 140, 150, 160, 170, 180, 190, 200, 210, 220, 230, 240, 250, 260, 270, 280, 290, 300, 310, 320, 330, 340, 350, 360, 370, 380, 390° C., or about 400° C. or more. The maximum temperature of the heated first flowable heat-transfer medium can be within any suitable range of the saturation temperature of the heated first flowable heat-transfer medium, such as within about 0-100° C., 0-60° C., about 0-40° C., or about 0° C., 1, 2, 3, 4, 5, 10, 15, 20, 25, 30, 35, 40, 50, 60, 70, 80, 90, or within about 100° C. of the saturation temperature of the heated first flowable heat-transfer medium. In various embodiments, the pressure of the first flowable heat-transfer medium and the heated first flowable heat-transfer medium can be analogously controlled so as to control the saturation temperature of the first flowable heat-transfer medium, in examples that include vaporization of the first heat-transfer medium. Controlling the temperature at which the first flowable heat-transfer medium vaporizes and the temperature at which the heated first flowable heat-transfer medium condenses (e.g., the saturation temperature) can control a temperature of the heated second flowable heat-transfer medium.

The first flowable heat-transfer medium and the heated first flowable heat-transfer medium can independently have any suitable vapor pressure, such as about 50 KPa to 1,000,000 KPa, 100 KPa to 500,000 KPa, or 500 KPa to 250,000 KPa, or about 50 KPa or less, or about 100 KPa, 500 KPa, 1 MPa, 2 MPa, 3, 4, 5, 6, 7, 8, 9, 10, 12.5, 15, 17.5, 20, 25, 30, 35, 40, 45, 50, 60, 70, 80, 90, 100, 125, 150, 175, 200 MPa, or about 250 MPa or more.

The first flowable heat-transfer medium and the heated first flowable heat-transfer medium can have any suitable heat capacity. For example, at about 100° C. or less, or at about 110° C., 120, 130, 140, 150, 160, 170, 180, 190, 200, 210, 220, 230, 240, 250, 260, 270, 280, 290, 300, 310, 320, 330, 340, 350, 360, 370, 380, 390° C., or at about 400° C. or more, the first flowable heat-transfer medium and the heated first flowable heat-transfer medium can have a heat capacity of about 0.2 KJ/Kg° C. to about 8.5 KJ/Kg° C., about 1 KJ/Kg° C. to about 4 KJ/Kg° C., about 0.2 KJ/Kg° C. or less, or about 0.5 KJ/Kg° C., 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.5, 4, 4.5, 5, 5.5, 6, 6.5, 7, 7.5, 8 KJ/Kg° C., or about 8.5 KJ/Kg° C. or more.

The first flowable heat-transfer medium can be circulated at any suitable rate, such as about 1 L/min to about 1,000,000 L/min, or about 10 L/min to about 100,000 L/min, or about 1 L/min or less, 10 L/min, 20, 30, 40, 50, 60, 70, 80, 90, 100, 125, 150, 175, 200, 225, 250, 275, 300, 350, 400, 450, 500, 600, 700, 800, 900, 1,000, 2,500, 5,000, 10,000, 50,000, 100,000, 500,000, or about 1,000,000 L/min or more.

### Second Flowable Heat-Transfer Medium.

In the method, system, or apparatus, the second flowable heat-transfer medium can be any suitable flowable heat-transfer medium. The second flowable heat-transfer medium can include one or more organic compounds with characteristics making the second flowable heat-transfer medium suitable for use in the methods, systems, and apparatus described herein. The second flowable heat-transfer medium can include, for example, at least one of water, a polyethylene glycol, a polypropylene glycol, a mineral oil, a silicone oil, diphenyl oxide, biphenyl, an inorganic salt, a terphenyl, a Therminol® brand heat-transfer fluid, and a Dowtherm™ brand heat-transfer fluid. The second flowable heat-transfer medium can include, for example, a Dowtherm™ brand heat-transfer fluid, such as at least one of Dowtherm™ A (e.g., diphenyl oxide and biphenyl, e.g., eutectic mixture of diphenyl oxide and biphenyl, e.g. 26.5 wt % diphenyl and 73.5 wt % diphenyl oxide), Dowtherm™ G (e.g., diaryl compounds, triaryl compounds, diaryl and triaryl ethers), Dowtherm™ J (e.g., alkylaryl compounds), Dowtherm™ MX (e.g., alkylaryl compounds), Dowtherm™ Q (e.g., diphenylethane, alkylaryl compounds), Dowtherm™ RP (e.g., diarylalkyl compounds), and Dowtherm™ T (e.g., C₁₄₋₃₀ alkyl benzenes). The second flowable heat-transfer medium can include, for example, trimethylpentane, a C₁₀₋₁₃ alkane, a C₁₀₋₁₃ iso-alkane, a C₁₄₋₃₀ alkylaryl compound, a diethylbenzene, an ethylenated benzene, a cyclohexylbenzene, a C₁₄₋₃₀ alkyl benzene, white petroleum mineral oil, ethyl diphenyl ethane, diphenyl ethane, diethyl diphenyl ethane, diphenyl ether, diphenyl oxide, ethylbenzene polymer, biphenyl, diisopropyl biphenyl, triisopropyl biphenyl, methylcyclohexane, bicyclohexyl, a terphenyl, a hydrogenated terphenyl, a partially hydrogenated quaterphenyls, a partially hydrogenated higher polyphenyl, diphenyl ether, and phenanthrene, a diaryl compound, a triaryl compound, a diaryl ether, a triaryl ether, an alkylaryl compound, an alkylaryl compound, a diarylalkyl compound, or a combination thereof.

The second flowable heat-transfer medium can have any suitable temperature. For example, the second flowable heat-transfer medium can be about 20° C. to 400° C., or about 50° C. to 350° C., 100° C. to 300° C., 100° C. to 200° C., 200° C. to 250° C., or about 250° C. to 300° C., or about 20° C. or less, or about 30° C., 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390° C., or about 400° C. or more. The second flowable heat-transfer medium can have any suitable phase, such as gas phase, liquid phase, or any suitable combination thereof. For example, the second flowable heat-transfer medium can be about 60% or less, or about 70%, 80, 85, 90, 95, 96, 97, 98, or about 99% or more gaseous phase, by weight. The second flowable heat-transfer medium can be substantially gaseous phase.

The heated second flowable heat-transfer medium can have any suitable temperature. For example, the heated second flowable heat-transfer medium can be about 100° C. to 500° C., 100° C. to 400° C., 100° C. to 300° C., 100° C. to 200° C., 200° C. to 250° C., 250° C. to 300° C., 300° C. to 350° C., 350° C. to 400° C., 400° C. to 500° C., 210° C. to 350° C., or 260° C. to 300° C., or about 100° C. or less, or about 110° C., 120, 130, 140, 150, 160, 170, 180, 190, 200, 210, 220, 230, 240, 250, 260, 270, 280, 290, 300, 310, 320, 330, 340, 350, 360, 370, 380, 390° C., or about 400° C. or more. The heated second flowable heat-transfer medium can have any suitable phase, such as gas phase, liquid phase, or any suitable combination thereof. For example, the heated second flowable heat-transfer medium can be about 60% or less, or about 70%, 80, 85, 90, 95, 96, 97, 98, or about 99% or more gaseous phase, by weight. The heated second flowable heat-transfer medium can be substantially gaseous phase.

During the transferring of heat from the heated first flowable heat-transfer medium to the second flowable heat-transfer medium, the second flowable heat-transfer medium can substantially become a gas (e.g., the second flowable heat-transfer medium can be substantially all vaporized). During the transferring of heat from the heated first flowable heat-transfer medium to the second flowable heat-transfer medium, the heat transferred to the second flowable heat-transfer medium can include substantially all latent heat (e.g., heat of vaporization). For example, during the transferring of heat from the heated first flowable heat-transfer medium to the second flowable heat-transfer medium, the heat transferred to the second flowable heat-transfer medium can include any suitable percentage of latent heat, such as about 60% to 100%, 70% to 100%, 80% to 100%, 90% to 100%, or about 60% or less, or about 65%, 70, 75, 80, 85, 90, 95, 96, 97, 98%, or about 99% or more latent heat (e.g., heat of vaporization), with the remainder being sensible heat.

During the transferring of heat from the heated second flowable heat-transfer medium to the at least one polyamide-containing component of a polyamide synthesis system, the heated second flowable heat-transfer medium can substantially condense into a liquid. For example, substantially all of the gaseous phase of the heated second flowable heat-transfer medium can condense. During the transferring of heat from the heated second flowable heat-transfer medium to the at least one polyamide-containing component of the polyamide synthesis system, the heat transferred from the second flowable heat-transfer medium can include substantially all latent heat (e.g., heat of vaporization). During the transferring of heat from the heated second flowable heat-transfer medium to the at least one polyamide-containing component of the polyamide synthesis system, the heat transferred from the second flowable heat-transfer medium can include any suitable percentage of latent heat, such as about 60% to 100%, 70% to 100%, 80% to 100%, 90% to 100%, or about 60% or less, or about 65%, 70, 75, 80, 85, 90, 95, 96, 97, 98%, or about 99% or more latent heat (e.g., heat of vaporization), with the remainder being sensible heat.

The method can include controlling a pressure of the second flowable heat-transfer medium and controlling a pressure of the heated second flowable heat-transfer medium to control a temperature at which the second flowable heat-transfer medium vaporizes and to control a temperature at which the heated second flowable heat-transfer medium condenses. The second heat-transfer medium and the heated second heat-transfer medium can be disposed in a second heating loop. Transferring heat from the heated second flowable heat-transfer medium to the at least one component of the polyamide synthesis system can provide a used second flowable heat-transfer medium. The method can include circulating the used second flowable heat-transfer medium back to the transferring of heat from the heated first flowable heat-transfer medium.

Controlling the pressure of the second flowable heat-transfer medium and controlling the pressure of the heated second flowable heat-transfer medium can include controlling a pressure in the second heating loop. The pressure can be controlled to be any suitable pressure, such as about 50 KPa to 1,000,000 KPa, 100 KPa to 500,000 KPa, or 500 KPa to 250,000 KPa, or about 50 KPa or less, or about 100 KPa, 500 KPa, 1 MPa, 2 MPa, 3, 4, 5, 6, 7, 8, 9, 10, 12.5, 15, 17.5, 20, 25, 30, 35, 40, 45, 50, 60, 70, 80, 90, 100, 125, 150, 175, 200 MPa, or about 250 MPa or more. In some examples the saturation temperature can be controlled to be any suitable temperature, such as about 100° C. to 500° C., 100° C. to 400° C., 100° C. to 300° C., 100° C. to 200° C., 200° C. to 250° C., 250° C. to 300° C., 300° C. to 350° C., 350° C. to 400° C., 400° C. to 500° C., 210° C. to 350° C., or 260° C. to 300° C., or about 100° C. or less, or about 110° C., 120, 130, 140, 150, 160, 170, 180, 190, 200, 210, 220, 230, 240, 250, 260, 270, 280, 290, 300, 310, 320, 330, 340, 350, 360, 370, 380, 390° C., or about 400° C. or more. The maximum temperature of the heated second flowable heat-transfer medium can be within any suitable range of the saturation temperature of the heated second flowable heat-transfer medium, such as within about 0-100° C., 0-60° C., about 0-40° C., or about 0° C., 1, 2, 3, 4, 5, 10, 15, 20, 25, 30, 35, 40, 50, 60, 70, 80, 90, or within about 100° C. of the saturation temperature of the heated second flowable heat-transfer medium. In various embodiments, the pressure of the first flowable heat-transfer medium and the heated first flowable heat-transfer medium can be analogously controlled so as to control the saturation temperature of the first flowable heat-transfer medium, in examples that include vaporization of the first heat-transfer medium.

Controlling the temperature at which the second flowable heat-transfer medium vaporizes and the temperature at which the heated second flowable heat-transfer medium condenses (e.g., the saturation temperature) can control a temperature of the at least one polyamide-containing component of the polyamide synthesis system. By controlling the pressure, and thereby controlling the saturation temperature of the second flowable heat-transfer medium, the temperature of the at least one polyamide-containing component of the polyamide synthesis system can be controlled to be any suitable temperature, such as about 100° C. to 500° C., 100° C. to 400° C., 100° C. to 300° C., 100° C. to 200° C., 200° C. to 250° C., 250° C. to 300° C., 300° C. to 350° C., 350° C. to 400° C., 400° C. to 500° C., 210° C. to 350° C., or 260° C. to 300° C., or about 100° C. or less, or about 110° C., 120, 130, 140, 150, 160, 170, 180, 190, 200, 210, 220, 230, 240, 250, 260, 270, 280, 290, 300, 310, 320, 330, 340, 350, 360, 370, 380, 390° C., or about 400° C. or more.

The second flowable heat-transfer medium and the heated second flowable heat-transfer medium can independently have any suitable vapor pressure, such as about 50 KPa to 1,000,000 KPa, 100 KPa to 500,000 KPa, or 500 KPa to 250,000 KPa, or about 50 KPa or less, or about 100 KPa, 500 KPa, 1 MPa, 2 MPa, 3, 4, 5, 6, 7, 8, 9, 10, 12.5, 15, 17.5, 20, 25, 30, 35, 40, 45, 50, 60, 70, 80, 90, 100, 125, 150, 175, 200 MPa, or about 250 MPa or more.

The second flowable heat-transfer medium and the heated second flowable heat-transfer medium can have any suitable heat capacity. For example, at about 100° C. or less, or at about 110° C., 120, 130, 140, 150, 160, 170, 180, 190, 200, 210, 220, 230, 240, 250, 260, 270, 280, 290, 300, 310, 320, 330, 340, 350, 360, 370, 380, 390° C., or at about 400° C. or more, the second flowable heat-transfer medium and the heated second flowable heat-transfer medium can have a heat capacity of about 0.2 KJ/Kg° C. to about 8.5 KJ/Kg° C., about 1 KJ/Kg° C. to about 4 KJ/Kg° C., about 0.2 KJ/Kg° C. or less, or about 0.5 KJ/Kg° C., 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.5, 4, 4.5, 5, 5.5, 6, 6.5, 7, 7.5, 8 KJ/Kg° C., or about 8.5 KJ/Kg° C. or more.

The difference between the temperature of the heated first flowable heat-transfer medium and the heated second flowable heat-transfer medium can be any suitable difference; for example, the difference can be about 0-300° C., 0-200° C., 0-100° C., 0-60° C., about 0-40° C., or about 0° C., 1, 2, 3, 4, 5, 10, 15, 20, 25, 30, 35, 40, 50, 60, 70, 80, 90, 100, 110, 120, 130, 140, 150, 160, 170, 180, 190, 200, 210, 220, 230, 240, 250, 260, 270, 280, 290° C., or about 300° C. or more. The difference between the temperature of the first flowable heat-transfer medium and the heated first flowable heat-transfer medium, and the difference between the temperature of the second flowable heat-transfer medium and the heated second flowable heat-transfer medium, can be any suitable difference; for example, the difference can independently be about 0-300° C., 0-200° C., 0-100° C., 0-60° C., about 0-40° C., or about 0° C., 1, 2, 3, 4, 5, 10, 15, 20, 25, 30, 35, 40, 50, 60, 70, 80, 90, 100, 110, 120, 130, 140, 150, 160, 170, 180, 190, 200, 210, 220, 230, 240, 250, 260, 270, 280, 290° C., or about 300° C. or more.

The second flowable heat-transfer medium can be circulated at any suitable rate, such as about 1 L/min to about 1,000,000 L/min, or about 10 L/min to about 100,000 L/min, or about 1 L/min or less, 10 L/min, 20, 30, 40, 50, 60, 70, 80, 90, 100, 125, 150, 175, 200, 225, 250, 275, 300, 350, 400, 450, 500, 600, 700, 800, 900, 1,000, 2,500, 5,000, 10,000, 50,000, 100,000, 500,000, or about 1,000,000 L/min or more.

### Other Flowable Heat-Transfer Medium.

In the method, system, or apparatus, the heat from the heated first flowable heat-transfer medium can be transferred to one or more than one second flowable heat-transfer medium. For example, a first heating loop containing the first flowable heat-transfer medium can be used to heat a multiplicity of other heating loops each containing a second flowable heat-transfer medium. In another example, a first heating loop containing the first flowable heat-transfer medium can be used to heat one or more second heating loops each containing a second flowable heat-transfer medium, and one or more third heating loops each containing a third flowable heat-transfer medium.

Transferring heat from the heated first flowable heat-transfer medium to the second flowable heat-transfer medium can provide a used first flowable heat-transfer medium. The method can include transferring heat from the used first flowable heat-transfer medium (e.g., series arrangement) or from the heated first flowable heat-transfer medium (e.g., parallel arrangement) to a third flowable heat-transfer medium, to provide a heated third flowable heat-transfer medium. The method can include transferring heat from the heated third flowable heat-transfer medium to at least one polyamide-containing component of the polyamide synthesis system. The third flowable heat-transfer medium can be any suitable heat-transfer medium described herein. The third flowable heat-transfer medium can be the same or different as the second heat-transfer medium. The at least one component of the polyamide synthesis system to which heat is transferred from the heated third flowable heat-transfer medium can be the same or different than the at least one component of the polyamide synthesis system to which heat is transferred from the heated second flowable heat-transfer medium.

### Polyamide

The polyamide made by the method, system, or apparatus can be any suitable polyamide. The polyamide can be synthesized from a linear dicarboxylic acid and a linear diamine or from an oligomer formed from a linear dicarboxylic acid and a linear diamine. The polyamide can be nylon-6,6. The finished polyamide can be generated at any suitable rate, such as about 1 L/min to about 1,000,000 L/min, or about 10 L/min to about 100,000 L/min, or about 1 L/min or less, 10 L/min, 20, 30, 40, 50, 60, 70, 80, 90, 100, 125, 150, 175, 200, 225, 250, 275, 300, 350, 400, 450, 500, 600, 700, 800, 900, 1,000, 2,500, 5,000, 10,000, 50,000, 100,000, 500,000, or about 1,000,000 L/min or more.

The dicarboxylic acid can be any suitable dicarboxylic acid. The dicarboxylic acid can have the structure HOC(O)—R¹—C(O)OH, wherein R¹ is a C₁-C₁₅ alkylene group, such as a methylene, ethylene, propylene, butylene, pentylene, hexylene, heptylene, octylene, nonylene, or decylene group. The dicarboxylic acid can be adipic acid (e.g., R¹=butylene).

The diamine can be any suitable diamine. The diamine can have the structure H₂N—R²—NH₂, wherein R² is a C₁-C₁₅ alkylene group, such as a methylene, ethylene, propylene, butylene, pentylene, hexylene, heptylene, octylene, nonylene, or decylene group. The diamine can be hexamethylenediamine, (e.g., R²=butylene).

### Examples

The present invention can be better understood by reference to the following examples which are offered by way of illustration. The present invention is not limited to the examples given herein. In all Examples, secondary heating loops are connected in parallel with the primary heating loop, although series arrangements and combinations of parallel and series arrangements are also within the scope of embodiments of the present invention.

### Example 1a

### Comparative Example. Liquid Phase Heat-Transfer Medium in Primary Heating Loop

Therminol® 66 is heated to about 340° C. and circulated through a primary heating loop in a nylon-6,6 manufacturing plant. The primary heating loop circulates the Therminol® 66 at a suitable flow rate between a powerhouse and heat exchangers on an evaporator, reactor, and finisher before transferring the Therminol® 66 back to the powerhouse for reheating. Approximately 10,000,000 L of Therminol® 66 is used in the primary heating loop. The Therminol® 66 remains a liquid throughout the process.

In the continuous nylon-6,6 manufacturing process, adipic acid and hexamethylenediamine are combined in an approximately equimolar ratio in water to form an aqueous mixture containing nylon-6,6 salt, having about 50 wt % water. The aqueous salt is transferred to an evaporator at approximately 105 L/min. Heat is transferred to the evaporator from the Therminol® 66 in the primary heating loop, allowing the evaporator to heat the aqueous salt to about 125-135° C. (130° C.) and remove water from the heated aqueous salt, bringing the water concentration to about 30 wt %. The evaporated salt mixture is transferred to a reactor at approximately 75 L/min. Heat is transferred to the reactor from the Therminol® 66 in the primary heating loop, bringing the temperature of the evaporated salt mixture to about 218-250° C. (235° C.), allowing the reactor to further remove water from the heated evaporated salt mixture and causing the salt to further polymerize and bringing the water concentration to about 10 wt %. The reacted mixture is transferred to a flasher at approximately 60 L/min. Heat is transferred to the flasher from the Therminol® 66 in the primary heating loop, heating the reacted mixture to about 270-290° C. (280° C.), allowing the flasher to further remove water from the reacted mixture and causing the reacted mixture to further polymerize, bringing the water concentration to about 0.5 wt %. The flashed mixture is transferred to a finisher at approximately 54 L/min, subjecting the polymeric mixture to a vacuum to further remove water, bringing the water concentration to about 0.1 wt %, such that the polyamide achieves a suitable final range of degree of polymerization before transferring the finished polymeric mixture to an extruder and a pelletizer.

The liquid Therminol® 66 requires large pumps to provide circulation of the material throughout the primary heating loop to all of the unit operations and back to the powerhouse for reheating. As compared to other methods using a heat transfer material that undergoes a phase change during the heat transfer, the total change in temperature of the Therminol® 66 per KJ of heat transferred per Kg of Therminol® 66 is larger; a higher rate of circulation and a larger surface area for heat transfer in the heat exchangers is used to accomplish the desired amount of heat transfer. Additionally, maintaining a precise temperature of each unit operation is difficult, since the temperature of the heat-transfer medium can only be adjusted overall and cannot be adjusted for an individual unit.

### Example 1b

### Comparative Example. Gas Phase Heat-Transfer Medium in Primary Heating Loop

Dowtherm™ A is heated to a vapor at about 340° C. and about 400 KPa pressure and circulated through a primary heating loop between a powerhouse and various unit operations in a nylon-6,6 manufacturing plant, where it transfers heat to the various unit operations before being transferred back to the powerhouse for reheating. Approximately 10,000,000 L of Dowtherm™ A is used in the primary heating loop. The Dowtherm™ A remains a vapor throughout the process, and is circulated at a sufficient rate that the material does not drop below the saturation temperature in the cycle.

The continuous nylon-6,6 manufacturing process is performed as described in Example 1a, but using the vaporous Dowtherm™ A throughout the process. As compared to other methods using a heat-transfer material that undergoes a phase change during the heat transfer, the total change in temperature of the Dowtherm™ A per KJ of heat transferred per Kg of Dowtherm™ A is larger; a higher rate of circulation and a larger surface area for heat transfer in the heat exchangers is used to accomplish the desired amount of heat transfer. Additionally, maintaining a precise temperature of each unit operation is difficult, since the temperature of the heat-transfer medium can only be adjusted overall and cannot be adjusted for an individual unit.

### Example 1c

### Comparative Example. Volatile Heat-Transfer Medium in Primary Heating Loop with Condensation

Example 1b was followed, but using Dowtherm™ A with a rate of circulation such that sufficient heat is absorbed from the Dowtherm™ A during heat transfer to the various unit operations to cause partial condensation of the Dowtherm™ A in the primary heating loop. To circulate the generated liquid to the remaining unit operations and back to the powerhouse, additional equipment is required, including a liquid knockout drum, additional piping, and pumps to return the condensate to the powerhouse for reheating and revaporization. Maintaining a precise temperature of each unit operation is difficult, since the temperature of the heat-transfer medium can only be adjusted overall and cannot be adjusted for an individual unit.

### Example 1d

### Comparative Example. Volatile Heat-Transfer Medium in Primary Heating Loop with Leak

Example 1b is followed.

A leak occurs in the primary heating loop. Due to the high pressure vapor used in the primary heating loop, the Dowtherm™ A vapors escape through the leak, lowering pressure throughout the entire primary heating loop. Due to the size of the primary heating loop, a large volume of vapors escape the leak before the pressure in the system drops to a level that allows the rate of leakage to slow. The escaped Dowtherm™ A vapors present a fire or explosion risk in and around the leak, including in areas having air spaces fluidly connected to the air space in the vicinity of the leak. In order to stop the leak, or to extinguish a fire fed by the leak, the entire primary heating loop in the plant must be shut down.

### Example 1e

### Comparative Example. Volative Heat-Transfer Medium in Primary Heating Loop with Leak

Example 1c is followed.

A leak occurs in the primary heating loop. Due to the high pressure vapor used in the primary heating loop, the Dowtherm™ A vapors escape through the leak, lowering pressure throughout the entire primary heating loop. Due to the size of the primary heating loop, a large volume of vapors escape the leak before the pressure in the system drops to a level that allows the rate of leakage to slow. The escaped Dowtherm™ A vapors present a fire or explosion risk in and around the leak, including in areas having air spaces fluidly connected to the air space in the vicinity of the leak. In order to stop the leak, or to extinguish a fire fed by the leak, the entire primary heating loop in the plant must be shut down.

### Example 2a

### Therminol® 66 in Primary Heating Loop with Evaporator, Reactor, and Flasher Heated Via Secondary Heating Loop

Therminol® 66 is heated to about 340° C. and circulated through a primary heating loop in a nylon-6,6 manufacturing plant. The primary heating loop circulates the Therminol® 66 between a powerhouse and heat exchangers on secondary heating loops, and heat exchangers on some individual unit operations. The secondary heating loops contain Dowtherm™ A, and are used to heat the evaporator, reactor, and flasher. The pressures of the secondary heating loops are independently adjusted to modify the vaporization and condensation temperatures of the Dowtherm™ A to precisely control the temperatures of each specific unit operation being heated. The primary heating loop contains about 10,000,000 L of Therminol® 66, and each secondary heating loop contains about 50,000 L of Dowtherm™ A.

In a continuous nylon-6,6 manufacturing process, adipic acid and hexamethylenediamine are combined in an approximately equimolar ratio in water to form an aqueous mixture containing nylon-6,6 salt and having about 50 wt % water. The aqueous salt is transferred to an evaporator at approximately 105 L/min. Heat is transferred to the evaporator from the Dowtherm™ A in a secondary heating loop for the evaporator, allowing the evaporator to heat the aqueous salt to about 125-135° C. (130° C.) and remove water from the heated aqueous salt, bringing the water concentration to about 30 wt %. The pressure for the secondary heating loop on the evaporator is adjusted to about 1 KPa to about 3 KPa (2 KPa), to maintain the saturation temperature of the Dowtherm™ A at about 130° C. The evaporated salt mixture is transferred to a reactor at approximately 75 L/min. Heat is transferred to the reactor from the Dowtherm™ A in a secondary heating loop for the reactor, bringing the temperature of the evaporated salt mixture to about 218-250° C. (235° C.), allowing the reactor to further remove water from the heated evaporated salt mixture, bringing the water concentration to about 10 wt %, and causing the salt to further polymerize. The pressure for the secondary heating loop on the reactor is adjusted to about 28 KPa to about 97 KPa (80 KPa), to maintain the saturation temperature of the Dowtherm™ A at about 235° C. The reacted mixture is transferred to a flasher at about 60 L/min. Heat is transferred to the flasher from the Dowtherm™ A in a secondary heating loop for the flasher, heating the reacted mixture to about 270-290° C. (280° C.), allowing the flasher to further remove water from the reacted mixture, bringing the water concentration to about 0.5 wt %, and causing the reacted mixture to further polymerize. The pressure for the secondary heating loop on the flasher is adjusted to about 150 KPa to about 200 KPa (180 KPa), to maintain the saturation temperature of the Dowtherm™ A at about 280° C. The flashed mixture is transferred to a finisher at about 54 L/min, subjecting the polymeric mixture to a vacuum to further remove water, bringing the water concentration to about 0.1 wt %, such that the polyamide achieves a suitable final range of degree of polymerization before transferring the finished polymeric mixture to an extruder and a pelletizer.

### Example 2b

### Therminol® 66 in Primary Heating Loop with Evaporator, Reactor, and Flasher Heated Via Secondary Heating Loop

Therminol® 66 is heated to about 340° C. and circulated through a primary heating loop in a nylon-6,6 manufacturing plant. The primary heating loop circulates the Therminol® 66 between a powerhouse and heat exchangers on secondary heating loops, and heat exchangers on some individual unit operations. The secondary heating loops contain Dowtherm™ A, and are used to heat the evaporator, reactor, and flasher. The pressures of the secondary heating loops are independently adjusted to modify the vaporization and condensation temperatures of the Dowtherm™ A to precisely control the temperatures of each specific unit operation being heated. The primary heating loop contains about 10,000,000 L of Therminol® 66, and each secondary heating loop contains about 50,000 L of Dowtherm™ A.

In a continuous nylon-6,6 manufacturing process, adipic acid and hexamethylenediamine are combined in an approximately equimolar ratio in water to form an aqueous mixture containing nylon-6,6 salt and having about 50 wt % water. The aqueous salt is transferred to an evaporator at approximately 105 L/min. Heat is transferred to the evaporator from the Dowtherm™ A in a secondary heating loop for the evaporator, allowing the evaporator to heat the aqueous salt to about 125-135° C. (130° C.) and remove water from the heated aqueous salt, bringing the water concentration to about 30 wt %. The pressure for the secondary heating loop on the evaporator is adjusted to about 1 KPa to about 3 KPa (2 KPa), to maintain the saturation temperature of the Dowtherm™ A at about 130° C. The heat transfer between the primary heating loop and the secondary heating loop, and the heat transfer between the secondary heating loop and the evaporator is primarily sensible heat, with the variation in temperature of the Dowtherm™ A in the secondary heating loop for the evaporator being no more than about 15° C. more or less than the saturation temperature of about 130° C. The evaporated salt mixture is transferred to a reactor at approximately 75 L/min. Heat is transferred to the reactor from the Dowtherm™ A in a secondary heating loop for the reactor, bringing the temperature of the evaporated salt mixture to about 218-250° C. (235° C.), allowing the reactor to further remove water from the heated evaporated salt mixture, bringing the water concentration to about 10 wt %, and causing the salt to further polymerize. The pressure for the secondary heating loop on the reactor is adjusted to about 28 KPa to about 97 KPa (80 KPa), to maintain the saturation temperature of the Dowtherm™ A at about 235° C. The heat transfer between the primary heating loop and the secondary heating loop, and the heat transfer between the secondary heating loop and the reactor is primarily sensible heat, with the variation in temperature of the Dowtherm™ A in the secondary heating loop for the reactor being no more than about 15° C. more or less than the saturation temperature of about 235° C. The reacted mixture is transferred to a flasher at about 60 L/min. Heat is transferred to the flasher from the Dowtherm™ A in a secondary heating loop for the flasher, heating the reacted mixture to about 270-290° C. (280° C.), allowing the flasher to further remove water from the reacted mixture, bringing the water concentration to about 0.5 wt %, and causing the reacted mixture to further polymerize. The pressure for the secondary heating loop on the flasher is adjusted to about 150 KPa to about 200 KPa (180 KPa), to maintain the saturation temperature of the Dowtherm™ A at about 280° C. The heat transfer between the primary heating loop and the secondary heating loop, and the heat transfer between the secondary heating loop and the flasher is primarily sensible heat, with the variation in temperature of the Dowtherm™ A in the secondary heating loop for the flasher being no more than about 15° C. more or less than the saturation temperature of about 280° C. The flashed mixture is transferred to a finisher at about 54 L/min, subjecting the polymeric mixture to a vacuum to further remove water, bringing the water concentration to about 0.1 wt %, such that the polyamide achieves a suitable final range of degree of polymerization before transferring the finished polymeric mixture to an extruder and a pelletizer.

### Example 2c

### Therminol® 66 in Primary Heating Loop with Evaporator, Reactor, and Flasher Heated Via Secondary Heating Loop, with Water in Secondary Loop for Evaporator

Therminol® 66 is heated to about 340° C. and circulated through a primary heating loop in a nylon-6,6 manufacturing plant. The primary heating loop circulates the Therminol® 66 between a powerhouse and heat exchangers on secondary heating loops, and heat exchangers on some individual unit operations. The secondary heating loops for the reactor and flasher contain Dowtherm™ A. The secondary heating loop for the evaporator contains water. The pressures of the secondary heating loops are independently adjusted to modify the vaporization and condensation temperatures of the Dowtherm™ A or water to precisely control the temperatures of each specific unit operation being heated. The primary heating loop contains about 10,000,000 L of Therminol® 66, and each secondary heating loop contains about 50,000 L of Dowtherm™ A or water.

In a continuous nylon-6,6 manufacturing process, adipic acid and hexamethylenediamine are combined in an approximately equimolar ratio in water to form an aqueous mixture containing nylon-6,6 salt and having about 50 wt % water. The aqueous salt is transferred to an evaporator at approximately 105 L/min. Heat is transferred to the evaporator from the water in a secondary heating loop for the evaporator, allowing the evaporator to heat the aqueous salt to about 125-135° C. (130° C.) and remove water from the heated aqueous salt, bringing the water concentration to about 30 wt %. The pressure for the secondary heating loop on the evaporator is adjusted to about 270 KPa to maintain the saturation temperature of the water at about 130° C. The heat transfer between the primary heating loop and the secondary heating loop, and the heat transfer between the secondary heating loop and the evaporator is primarily sensible heat, with the variation in temperature of the water in the secondary heating loop for the evaporator being no more than about 15° C. more or less than the saturation temperature of about 130° C. The evaporated salt mixture is transferred to a reactor at approximately 75 L/min. Heat is transferred to the reactor from the Dowtherm™ A in a secondary heating loop for the reactor, bringing the temperature of the evaporated salt mixture to about 218-250° C. (235° C.), allowing the reactor to further remove water from the heated evaporated salt mixture, bringing the water concentration to about 10 wt %, and causing the salt to further polymerize. The pressure for the secondary heating loop on the reactor is adjusted to about 28 KPa to about 97 KPa (80 KPa), to maintain the saturation temperature of the Dowtherm™ A at about 235° C. The heat transfer between the primary heating loop and the secondary heating loop, and the heat transfer between the secondary heating loop and the reactor is primarily sensible heat, with the variation in temperature of the Dowtherm™ A in the secondary heating loop for the reactor being no more than about 15° C. more or less than the saturation temperature of about 235° C. The reacted mixture is transferred to a flasher at about 60 L/min. Heat is transferred to the flasher from the Dowtherm™ A in a secondary heating loop for the flasher, heating the reacted mixture to about 270-290° C. (280° C.), allowing the flasher to further remove water from the reacted mixture, bringing the water concentration to about 0.5 wt %, and causing the reacted mixture to further polymerize. The pressure for the secondary heating loop on the flasher is adjusted to about 150 KPa to about 200 KPa (180 KPa), to maintain the saturation temperature of the Dowtherm™ A at about 280° C. The heat transfer between the primary heating loop and the secondary heating loop, and the heat transfer between the secondary heating loop and the flasher is primarily sensible heat, with the variation in temperature of the Dowtherm™ A in the secondary heating loop for the flasher being no more than about 15° C. more or less than the saturation temperature of about 280° C. The flashed mixture is transferred to a finisher at about 54 L/min, subjecting the polymeric mixture to a vacuum to further remove water, bringing the water concentration to about 0.1 wt %, such that the polyamide achieves a suitable final range of degree of polymerization before transferring the finished polymeric mixture to an extruder and a pelletizer.

### Example 3a

### Therminol® 66 in Primary Heating Loop with Evaporator Heated Via Secondary Heating Loop and Reactor and Flasher Heated Via Primary Heating Loop

Therminol® 66 is heated to about 340° C. and circulated through a primary heating loop in a nylon-6,6 manufacturing plant. The primary heating loop circulates the Therminol® 66 between a powerhouse and heat exchangers on secondary heating loops, and heat exchangers on some individual unit operations. The secondary heating loop contains Dowtherm™ A, and are used to heat the evaporator. The pressure of the secondary heating loop is adjusted to modify the vaporization and condensation temperature of the Dowtherm™ A to precisely control the temperature of the evaporator. The primary heating loop contains about 10,000,000 L of Therminol® 66, and the secondary heating loop contains about 50,000 L of Dowtherm™ A.

In a continuous nylon-6,6 manufacturing process, adipic acid and hexamethylenediamine are combined in an approximately equimolar ratio in water to form an aqueous mixture containing nylon-6,6 salt and having a water concentration of about 50 wt %. The aqueous salt is transferred to an evaporator at about 105 L/min. Heat is transferred to the evaporator from the Dowtherm™ A in a secondary heating loop for the evaporator, allowing the evaporator to heat the aqueous salt to about 125-135° C. (130° C.) and remove water from the heated aqueous salt, bringing the water concentration to about 30 wt %. The pressure for the secondary heating loop on the evaporator is adjusted to about 1 KPa to about 3 KPa (2 KPa), to maintain the saturation temperature of the Dowtherm™ A at about 130° C. The heat transfer between the primary heating loop and the secondary heating loop, and the heat transfer between the secondary heating loop and the evaporator is primarily sensible heat, with the variation in temperature of the Dowtherm™ A in the secondary heating loop for the evaporator being no more than about 15° C. more or less than the saturation temperature of about 130° C. The evaporated salt mixture is transferred to a reactor at about 75 L/min. Heat is transferred to the reactor from the Therminol® 66 in the primary heating loop, bringing the temperature of the evaporated salt mixture to about 218-250° C. (235° C.), allowing the reactor to further remove water from the heated evaporated salt mixture, bringing the water concentration to about 10 wt %, and causing the salt to further polymerize. The reacted mixture is transferred to a flasher at about 60 L/min. Heat is transferred to the flasher from the Therminol® 66 in the primary heating loop, heating the reacted mixture to about 270-290° C. (280° C.), allowing the flasher to further remove water from the reacted mixture, bringing the water concentration to about 0.5 wt %, and causing the reacted mixture to further polymerize. The flashed mixture is transferred to a finisher at about 54 L/min, subjecting the polymeric mixture to a vacuum to further remove water, bringing the water concentration to about 0.1 wt %, such that the polyamide achieves a suitable final range of degree of polymerization before transferring the finished polymeric mixture to an extruder and a pelletizer.

### Example 3b

### Therminol® 66 in Primary Heating Loop with Evaporator Heated Via Secondary Heating Loop and Reactor and Flasher Heated Via Primary Heating Loop

Therminol® 66 is heated to about 340° C. and circulated through a primary heating loop in a nylon-6,6 manufacturing plant. The primary heating loop circulates the Therminol® 66 between a powerhouse and heat exchangers on secondary heating loops, and heat exchangers on some individual unit operations. The secondary heating loop contains water is used to heat the evaporator. The pressure of the secondary heating loop is adjusted to modify the vaporization and condensation temperature of the water to precisely control the temperature of the evaporator. The primary heating loop contains about 10,000,000 L of Therminol® 66, and the secondary heating loop contains about 50,000 L of water.

In a continuous nylon-6,6 manufacturing process, adipic acid and hexamethylenediamine are combined in an approximately equimolar ratio in water to form an aqueous mixture containing nylon-6,6 salt and having a water concentration of about 50 wt %. The aqueous salt is transferred to an evaporator at about 105 L/min. Heat is transferred to the evaporator from the Dowtherm™ A in a secondary heating loop for the evaporator, allowing the evaporator to heat the aqueous salt to about 125-135° C. (130° C.) and remove water from the heated aqueous salt, bringing the water concentration to about 30 wt %. The pressure for the secondary heating loop on the evaporator is adjusted to about 270 KPa, to maintain the saturation temperature of the water at about 130° C. The heat transfer between the primary heating loop and the secondary heating loop, and the heat transfer between the secondary heating loop and the evaporator is primarily sensible heat, with the variation in temperature of the water in the secondary heating loop for the evaporator being no more than about 15° C. more or less than the saturation temperature of about 130° C. The evaporated salt mixture is transferred to a reactor at about 75 L/min. Heat is transferred to the reactor from the Therminol® 66 in the primary heating loop, bringing the temperature of the evaporated salt mixture to about 218-250° C. (235° C.), allowing the reactor to further remove water from the heated evaporated salt mixture, bringing the water concentration to about 10 wt %, and causing the salt to further polymerize. The reacted mixture is transferred to a flasher at about 60 L/min. Heat is transferred to the flasher from the Therminol® 66 in the primary heating loop, heating the reacted mixture to about 270-290° C. (280° C.), allowing the flasher to further remove water from the reacted mixture, bringing the water concentration to about 0.5 wt %, and causing the reacted mixture to further polymerize. The flashed mixture is transferred to a finisher at about 54 L/min, subjecting the polymeric mixture to a vacuum to further remove water, bringing the water concentration to about 0.1 wt %, such that the polyamide achieves a suitable final range of degree of polymerization before transferring the finished polymeric mixture to an extruder and a pelletizer.

### Example 4

### Therminol® 66 in Primary Heating Loop with Reactor Heated Via Secondary Heating Loop and Evaporator and Flasher Heated Via Primary Heating Loop

Therminol® 66 is heated to about 340° C. and circulated through a primary heating loop in a nylon-6,6 manufacturing plant. The primary heating loop circulates the Therminol® 66 between a powerhouse and heat exchangers on secondary heating loops, and heat exchangers on some individual unit operations. The secondary heating loop contains Dowtherm™ A, and is used to heat the reactor. The pressure of the secondary heating loop is adjusted to modify the vaporization and condensation temperature of the Dowtherm™ A to precisely control the temperature of the reactor. The primary heating loop contains about 10,000,000 L of Therminol® 66, and the secondary heating loop contains about 50,000 L of Dowtherm™ A.

In a continuous nylon-6,6 manufacturing process, adipic acid and hexamethylenediamine are combined in an approximately equimolar ratio in water to form an aqueous mixture containing nylon-6,6 salt and having about 50 wt % water. The aqueous salt is transferred to an evaporator at about 105 L/min. Heat is transferred to the evaporator from the Therminol® 66 in the primary heating loop, allowing the evaporator to heat the aqueous salt to about 125-135° C. (130° C.) and remove water from the heated aqueous salt, bringing the water concentration to about 30 wt %. The evaporated salt mixture is transferred to a reactor at about 75 L/min. Heat is transferred to the reactor from the Dowtherm™ A in a secondary heating loop for the reactor, bringing the temperature of the evaporated salt mixture to about 218-250° C. (235° C.), allowing the reactor to further remove water from the heated evaporated salt mixture, bringing the water concentration to about 10 wt %, and causing the salt to further polymerize. The pressure for the secondary heating loop on the reactor is adjusted to about 28 KPa to about 97 KPa (80 KPa), to maintain the saturation temperature of the Dowtherm™ A at about 235° C. The heat transfer between the primary heating loop and the secondary heating loop, and the heat transfer between the secondary heating loop and the reactor is primarily sensible heat, with the variation in temperature of the Dowtherm™ A in the secondary heating loop for the reactor being no more than about 15° C. more or less than the saturation temperature of about 235° C. The reacted mixture is transferred to a flasher at about 60 L/min. Heat is transferred to the flasher from the Therminol® 66 in the primary heating loop, heating the reacted mixture to about 270-290° C. (280° C.), allowing the flasher to further remove water from the reacted mixture, bringing the water concentration to about 0.5 wt %, and causing the reacted mixture to further polymerize. The flashed mixture is transferred to a finisher at about 54 L/min, subjecting the polymeric mixture to a vacuum to further remove water, bringing the water concentration to about 0.1 wt %, such that the polyamide achieves a suitable final range of degree of polymerization before transferring the finished polymeric mixture to an extruder and a pelletizer.

### Example 5

### Therminol® 66 in Primary Heating Loop with Flasher Heated Via Secondary Heating Loop and Evaporator and Reactor Heated Via Primary Heating Loop

Therminol® 66 is heated to about 340° C. and circulated through a primary heating loop in a nylon-6,6 manufacturing plant. The primary heating loop circulates the Therminol® 66 between a powerhouse and heat exchangers on secondary heating loops, and heat exchangers on some individual unit operations. The secondary heating loop contains Dowtherm™ A, and is used to heat the flasher. The pressure of the secondary heating loop is adjusted to modify the vaporization and condensation temperature of the Dowtherm™ A to precisely control the temperature of the flasher. The primary heating loop contains about 10,000,000 L of Therminol® 66, and the secondary heating loop contains about 50,000 L of Dowtherm™ A.

In a continuous nylon-6,6 manufacturing process, adipic acid and hexamethylenediamine are combined in an approximately equimolar ratio in water to form an aqueous mixture containing nylon-6,6 salt and having about 50 wt % water. The aqueous salt is transferred to an evaporator at about 105 L/min. Heat is transferred to the evaporator from the Therminol® 66 in the primary heating loop, allowing the evaporator to heat the aqueous salt to about 125-135° C. (130° C.) and remove water from the heated aqueous salt, bringing the water concentration to about 30 wt %. The evaporated salt mixture is transferred to a reactor at about 75 L/min. Heat is transferred to the reactor from the Therminol® 66 in the primary heating loop, bringing the temperature of the evaporated salt mixture to about 218-250° C. (235° C.), allowing the reactor to further remove water from the heated evaporated salt mixture, bringing the water concentration to about 10 wt %, and causing the salt to further polymerize. The reacted mixture is transferred to a flasher at about 60 L/min. Heat is transferred to the flasher from the Dowtherm™ A in a secondary heating loop for the flasher, heating the reacted mixture to about 270-290° C. (280° C.), allowing the flasher to further remove water from the reacted mixture, bringing the water concentration to about 0.5 wt %, and causing the reacted mixture to further polymerize. The pressure for the secondary heating loop on the flasher is adjusted to about 150 KPa to about 200 KPa (180 KPa), to maintain the saturation temperature of the Dowtherm™ A at about 280° C. The heat transfer between the primary heating loop and the secondary heating loop, and the heat transfer between the secondary heating loop and the flasher is primarily sensible heat, with the variation in temperature of the Dowtherm™ A in the secondary heating loop for the flasher being no more than about 15° C. more or less than the saturation temperature of about 280° C. The flashed mixture is transferred to a finisher at about 54 L/min, subjecting the polymeric mixture to a vacuum to further remove water, bringing the water concentration to about 0.1 wt %, such that the polyamide achieves a suitable final range of degree of polymerization before transferring the finished polymeric mixture to an extruder and a pelletizer.

### Example 6

### Therminol® 66 in Primary Heating Loop with Salt Strike Heated Via Secondary Heating Loop and Salt Evaporator, Reactor, and Flasher Heated Via Primary Heating Loop

Therminol® 66 is heated to about 340° C. and circulated through a primary heating loop in a nylon-6,6 manufacturing plant. The primary heating loop circulates the Therminol® 66 between a powerhouse and heat exchangers on secondary heating loops, and heat exchangers on some individual unit operations. The secondary heating loop contains water, and is used to heat the salt strike. The pressure of the secondary heating loop is adjusted to modify the vaporization and condensation temperature of the water to precisely control the temperature of the salt strike. The primary heating loop contains about 10,000,000 L of Therminol® 66, and the secondary heating loop contains about 50,000 L of water.

In a continuous nylon-6,6 manufacturing process, adipic acid and hexamethylenediamine are combined in a salt strike in an approximately equimolar ratio in water to form an aqueous mixture containing nylon-6,6 salt having a water content of about 50 wt %. Heat is transferred to the salt strike from water in a secondary heating loop for the salt strike, bringing the temperature of the aqueous mixture to about 50-100° C. (75° C.). The pressure for the secondary heating loop on the salt strike is adjusted to about 40 KPa, to maintain the saturation temperature of the water at about 75° C. The heat transfer between the primary heating loop and the secondary heating loop, and the heat transfer between the secondary heating loop and the salt strike is primarily sensible heat, with the variation in temperature of the water in the secondary heating loop for the salt strike being no more than about 15° C. more or less than the saturation temperature of about 75° C. The aqueous salt is transferred to an evaporator at about 105 L/min. Heat is transferred to the evaporator from the Therminol® 66 in the primary heating loop, allowing the evaporator to heat the aqueous salt to about 125-135° C. (130° C.) and remove water from the heated aqueous salt, bringing the water concentration to about 30 wt %. The evaporated salt mixture is transferred to a reactor at about 75 L/min. Heat is transferred to the reactor from the Therminol® 66 in the primary heating loop, bringing the temperature of the evaporated salt mixture to about 218-250° C. (235° C.), allowing the reactor to further remove water from the heated evaporated salt mixture, bringing the water concentration to about 10 wt %, and causing the salt to further polymerize. The reacted mixture is transferred to a flasher at about 60 L/min. Heat is transferred to the flasher from the Therminol® 66 in the primary heating loop, heating the reacted mixture to about 270-290° C. (280° C.), allowing the flasher to further remove water from the reacted mixture, bringing the water concentration to about 0.5 wt %, and causing the reacted mixture to further polymerize. The flashed mixture is transferred to a finisher at about 54 L/min, subjecting the polymeric mixture to a vacuum to further remove water, bringing the water concentration to about 0.1 wt %, such that the polyamide achieves a suitable final range of degree of polymerization before transferring the finished polymeric mixture to an extruder and a pelletizer.

### Example 7

### Batch Process, Therminol® 66 in Primary Heating Loop with Autoclave Heated Via Secondary Heating Loop

Therminol® 66 is heated to about 340° C. and circulated through a primary heating loop in a nylon-6,6 manufacturing plant. The primary heating loop circulates the Therminol® 66 between a powerhouse and heat exchangers on secondary heating loops, and heat exchangers on some individual unit operations. The secondary heating loop contains Dowtherm™ A, and is used to heat the autoclave. The pressure of the secondary heating loop is adjusted to modify the vaporization and condensation temperature of the Dowtherm™ A to control the temperature of the reactor. The primary heating loop contains about 10,000,000 L of Therminol® 66, and the secondary heating loop contains about 50,000 L of Dowtherm™ A.

In a batch nylon-6,6 manufacturing process, adipic acid and hexamethylenediamine are combined in an approximately equimolar ratio in water to form an aqueous mixture containing nylon-6,6 salt having about 50 wt % water. The aqueous salt is transferred to an evaporator at about 105 L/min. Heat is transferred to the evaporator from the Therminol® 66 in the primary heating loop, allowing the evaporator to heat the aqueous salt to about 125-135° C. (130° C.) and remove water from the heated aqueous salt, bringing the water concentration to about 30 wt %. The evaporated salt mixture is transferred to an autoclave in a batch of about 100,000 L. Heat is transferred to the reactor from the Dowtherm™ A in the secondary heating loop, bringing the temperature of the mixture to about 270-290° C. (280° C.), removing water therefrom, bringing the water concentration to about 0.1 wt %, and such that the polyamide achieves a suitable final range of degree of polymerization. The pressure for the secondary heating loop on the autoclave is adjusted to about 150 KPa to about 200 KPa (180 KPa), to maintain the saturation temperature of the Dowtherm™ A at about 280° C. The heat transfer between the primary heating loop and the secondary heating loop, and the heat transfer between the secondary heating loop and the autoclave is primarily sensible heat, with the variation in temperature of the Dowtherm™ A in the secondary heating loop for the autoclave being no more than about 15° C. more or less than the saturation temperature of about 280° C. The finished polymeric mixture is transferred to an extruder and a pelletizer.

### Example 8

### Therminol® 66 in Primary Heating Loop with Evaporator, Reactor, and Flasher Heated Via Secondary Heating Loop, with a Leak in Primary Heating Loop

Example 2a is followed. A leak occurs in the primary heating loop, allowing the contents to enter the plant environment.

The liquid Therminol® 66 that exits the leak is under a relatively low pressure, limiting the total discharge of material. Since the liquid Therminol® 66 that has discharged is relatively nonvolatile the risk of explosion is nearly zero and the risk of fire is low and contained to the immediate vicinity of the leak.

### Example 9

### Therminol® 66 in Primary Heating Loop with Evaporator, Reactor, and Flasher Heated Via Secondary Heating Loop, with a Leak in a Secondary Heating Loop

Example 2a is followed. A leak occurs in the secondary heating loop on the evaporator.

As compared to Examples 1d and 1e, the smaller volume of volatile Dowtherm™ A used in secondary heating loop significantly reduces the safety hazards associated with using pressurized high temperature flammable vapors. The smaller volume of the secondary heating loop, as compared to the primary heating loop in Examples 1d and 1e, limits the amount of discharge that occurs. The majority of the heating system in the plant can continue to operate while the Dowtherm™ A-containing secondary loop is shut down to fix leaks or to extinguish fires.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Modification and variation of the concepts herein disclosed may be resorted to by those of ordinary skill in the art, and such modifications and variations are considered to be within the scope of this invention as defined by the appended claims.

### STATEMENTS OF THE INVENTION

The present invention provides for at least the following, the numbering of which is not to be construed as designating levels of importance:

Statement 1 provides a method of making a polyamide, the method comprising: heating a first flowable heat-transfer medium, to provide a heated first flowable heat-transfer medium; transferring heat from the heated first flowable heat-transfer medium to a second flowable heat-transfer medium, to provide a heated second flowable heat-transfer medium; and transferring heat from the heated second flowable heat-transfer medium to at least one polyamide-containing component of a polyamide synthesis system.

Statement 2 provides the method of Statement 1, wherein the polyamide synthesis system synthesizes the polyamide from a linear dicarboxylic acid and a linear diamine or from an oligomer formed from a linear dicarboxylic acid and a linear diamine.

Statement 3 provides the method of Statement 2, wherein the dicarboxylic acid has the structure HOC(O)—R¹—C(O)OH, wherein R¹ is a C₁-C₁₅ alkylene group.

Statement 4 provides the method of Statement 3, wherein the dicarboxylic acid is adipic acid.

Statement 5 provides the method of any one of Statements 2-4, wherein the diamine has the structure H₂N—R²—NH₂, wherein R² is a C₁-C₁₅ alkylene group.

Statement 6 provides the method of Statement 5, wherein the diamine is hexamethylenediamine.

Statement 7 provides the method of any one of Statements 2-6, wherein the polyamide is nylon-6,6.

Statement 8 provides the method of any one of Statements 1-7, wherein the at least one component of the polyamide synthesis system comprises at least one of a preheater, an evaporator, a polymerization reactor, a flasher, a finisher, and an autoclave.

Statement 9 provides the method of any one of Statements 1-8, wherein at standard temperature and pressure, the first flowable heat-transfer medium has a lower vapor pressure than the second flowable heat-transfer medium.

Statement 10 provides the method of any one of Statements 1-9, wherein the heated second flowable heat-transfer medium has a higher vapor pressure than the heated first flowable heat-transfer medium.

Statement 11 provides the method of any one of Statements 1-10, wherein the heated second flowable heat-transfer medium is at least one of more flammable and more combustible than the heated first flowable heat-transfer medium.

Statement 12 provides the method of any one of Statements 1-11, wherein the first flowable heat-transfer medium comprises at least one of water, a polyethylene glycol, a polypropylene glycol, a mineral oil, a silicone oil, diphenyl oxide, and biphenyl.

Statement 13 provides the method of any one of Statements 1-12, wherein the first flowable heat-transfer medium is at least one of trimethylpentane, a C₁₀₋₁₃ alkane, a C₁₀₋₁₃ iso-alkane, a C₁₄₋₃₀ alkylaryl compound, a diethylbenzene, an ethylenated benzene, a cyclohexylbenzene, a C₁₄₋₃₀ alkyl benzene, white petroleum mineral oil, ethyl diphenyl ethane, diphenyl ethane, diethyl diphenyl ethane, diphenyl ether, diphenyl oxide, ethylbenzene polymer, biphenyl, an inorganic salt, diisopropyl biphenyl, triisopropyl biphenyl, methylcyclohexane, bicyclohexyl, a terphenyl, a hydrogenated terphenyl, a partially hydrogenated quaterphenyls, a partially hydrogenated higher polyphenyl, diphenyl ether, and phenanthrene, a diaryl compound, a triaryl compound, a diaryl ether, a triaryl ether, an alkylaryl compound, an alkylaryl compound, and a diarylalkyl compound.

Statement 14 provides the method of any one of Statements 1-13, wherein the heated first flowable heat-transfer medium is about 280° C. to about 400° C.

Statement 15 provides the method of any one of Statements 1-14, wherein the heated first flowable heat-transfer medium is about 330° C. to about 350° C.

Statement 16 provides the method of any one of Statements 1-15, wherein the first flowable heat-transfer medium and the heated first flowable heat-transfer medium are substantially liquid phase.

Statement 17 provides the method of any one of Statements 1-16, wherein during the heating of the first flowable heat-transfer medium, the first flowable heat-transfer medium substantially remains a liquid.

Statement 18 provides the method of any one of Statements 1-17, wherein during the heating of the first flowable heat-transfer medium, substantially no vaporization of the first flowable heat-transfer medium occurs.

Statement 19 provides the method of any one of Statements 1-18, wherein during the heating of the first flowable heat-transfer medium, the heat transferred to the first flowable heat-transfer medium comprises substantially all sensible heat.

Statement 20 provides the method of any one of Statements 1-19, wherein during the transferring of heat from the heated first flowable heat-transfer medium to the second flowable heat-transfer medium, the heated first flowable heat-transfer medium substantially remains a liquid.

Statement 21 provides the method of any one of Statements 1-20, wherein during the transferring of heat from the heated first flowable heat-transfer medium to the second flowable heat-transfer medium, substantially no condensation of the heated first flowable heat-transfer medium occurs.

Statement 22 provides the method of any one of Statements 1-21, wherein during the transferring of heat from the heated first flowable heat-transfer medium to the second flowable heat-transfer medium, the heat transferred from the heated first flowable heat-transfer medium comprises substantially all sensible heat.

Statement 23 provides the method of any one of Statements 1-22, wherein the first flowable heat-transfer medium and the heated first-flowable heat-transfer medium are disposed in a first heating loop.

Statement 24 provides the method of any one of Statements 1-23, wherein transferring heat from the heated first flowable heat-transfer medium to the second flowable heat-transfer medium provides a used first flowable heat-transfer medium, further comprising circulating the used first flowable heat-transfer medium back to the heating of the first flowable heat-transfer medium.

Statement 25 provides the method of any one of Statements 1-24, wherein the second flowable heat-transfer medium is at least one of water, a polyethylene glycol, a polypropylene glycol, a mineral oil, a silicone oil, diphenyl oxide, biphenyl, and a terphenyl.

Statement 26 provides the method of any one of Statements 1-25, wherein the second flowable heat-transfer medium is at least one of trimethylpentane, a C₁₀₋₁₃ alkane, a C₁₀₋₁₃ iso-alkane, a C₁₄₋₃₀ alkylaryl compound, a diethylbenzene, an ethylenated benzene, a cyclohexylbenzene, a C₁₄₋₃₀ alkyl benzene, white petroleum mineral oil, ethyl diphenyl ethane, diphenyl ethane, diethyl diphenyl ethane, diphenyl ether, diphenyl oxide, ethylbenzene polymer, biphenyl, an inorganic salt, diisopropyl biphenyl, triisopropyl biphenyl, methylcyclohexane, bicyclohexyl, a terphenyl, a hydrogenated terphenyl, a partially hydrogenated quaterphenyls, a partially hydrogenated higher polyphenyl, diphenyl ether, and phenanthrene, a diaryl compound, a triaryl compound, a diaryl ether, a triaryl ether, an alkylaryl compound, an alkylaryl compound, and a diarylalkyl compound.

Statement 27 provides the method of any one of Statements 1-26, wherein the heated second flowable heat-transfer medium is about 210° C. to about 350° C.

Statement 28 provides the method of any one of Statements 1-27, wherein the heated second flowable heat-transfer medium is about 260° C. to about 300° C.

Statement 29 provides the method of any one of Statements 1-28, wherein the heated second flowable heat-transfer medium is substantially liquid phase.

Statement 30 provides the method of any one of Statements 1-29, wherein the heated second flowable heat-transfer medium is substantially gas phase.

Statement 31 provides the method of any one of Statements 1-30, wherein during the transferring of heat from the heated first flowable heat-transfer medium to the second flowable heat-transfer medium, the second flowable heat-transfer medium substantially becomes a gas.

Statement 32 provides the method of any one of Statements 1-31, wherein during the transferring of heat from the heated first flowable heat-transfer medium to the second flowable heat-transfer medium, the second flowable heat-transfer medium is substantially all vaporized.

Statement 33 provides the method of Statement 32, further comprising controlling a pressure of the second flowable heat-transfer medium to control a temperature at which the second flowable heat-transfer medium vaporizes.

Statement 34 provides the method of Statement 33, wherein the second heat-transfer medium and the heated second heat-transfer medium are disposed in a second heating loop, wherein controlling the pressure of the second flowable heat-transfer medium comprises controlling a pressure in the second heating loop.

Statement 35 provides the method of any one of Statements 33-34, wherein controlling the temperature at which the second flowable heat-transfer medium vaporizes controls a temperature of the at least one polyamide-containing component of the polyamide synthesis system.

Statement 36 provides the method of any one of Statements 1-35, wherein during the transferring of heat from the heated first flowable heat-transfer medium to the second flowable heat-transfer medium, the heat transferred to the second flowable heat-transfer medium comprises substantially all latent heat comprising heat of vaporization.

Statement 37 provides the method of any one of Statements 1-36, wherein during the transferring of heat from the heated first flowable heat-transfer medium to the second flowable heat-transfer medium, the heat transferred to the second flowable heat-transfer medium comprises about 70-100% latent heat comprising heat of vaporization, and about 0-30% sensible heat.

Statement 38 provides the method of any one of Statements 1-37, wherein during the transferring of heat from the heated second flowable heat-transfer medium to the at least one polyamide-containing component of the polyamide synthesis system, the heated second flowable heat-transfer medium substantially condenses into a liquid.

Statement 39 provides the method of Statement 38, further comprising controlling a pressure of the heated second flowable heat-transfer medium to adjust a temperature at which the heated second flowable heat-transfer medium undergoes the at least partial condensation.

Statement 40 provides the method of Statement 39, wherein controlling the temperature at which the heated second flowable heat-transfer medium undergoes the at least partial condensation controls the temperature of the at least one polyamide-containing component of the polyamide synthesis system.

Statement 41 provides the method of any one of Statements 39-40, wherein the second heat-transfer medium and the heated second heat-transfer medium are disposed in a second heating loop, wherein controlling the pressure of the heated second flowable heat-transfer medium comprises controlling a pressure in the second heating loop.

Statement 42 provides the method of Statement 41, wherein controlling the pressure in the second heating loop comprises controlling the saturation temperature of the heated second flowable heat-transfer medium.

Statement 43 provides the method of Statement 42, wherein a maximum temperature of the heated second flowable heat-transfer medium is within about 0-40° C. of the saturation temperature of the heated second flowable heat-transfer medium.

Statement 44 provides the method of any one of Statements 1-43, wherein during the transferring of heat from the heated second flowable heat-transfer medium to the at least one polyamide-containing component of the polyamide synthesis system, the heat transferred from the heated second flowable heat-transfer medium comprises substantially all latent heat comprising heat of vaporization.

Statement 45 provides the method of any one of Statements 1-44, wherein during the transferring of heat from the heated second flowable heat-transfer medium to the at least one polyamide-containing component of the polyamide synthesis system, the heat transferred from the second flowable heat-transfer medium comprises about 70-100% latent heat comprising heat of vaporization, and about 0-30% sensible heat.

Statement 46 provides the method of any one of Statements 1-45, wherein transferring heat from the heated second flowable heat-transfer medium to the at least one component of the polyamide synthesis system provides a used second flowable heat-transfer medium, further comprising circulating the used second flowable heat-transfer medium back to the transferring of heat from the heated first flowable heat-transfer medium.

Statement 47 provides the method of any one of Statements 1-46, wherein transferring heat from the heated second flowable heat-transfer medium to the at least one component of the polyamide synthesis system comprises maintaining the temperature of the at least one component of the polyamide synthesis system at about 150° C. to about 350° C.

Statement 48 provides the method of any one of Statements 1-47, wherein transferring heat from the heated second flowable heat-transfer medium to the at least one component of the polyamide synthesis system comprises maintaining the temperature of the at least one component of the polyamide synthesis system at about 210° C. to about 260° C.

Statement 49 provides the method of any one of Statements 1-48, wherein transferring heat from the heated second flowable heat-transfer medium to the at least one component of the polyamide synthesis system comprises maintaining the temperature of a polyamide mixture in a reactor at about 218° C. to about 250° C.

Statement 50 provides the method of any one of Statements 1-49, wherein transferring heat from the heated first flowable heat-transfer medium to the second flowable heat-transfer medium provides a used first flowable heat-transfer medium, further comprising transferring heat from the used first flowable heat-transfer medium or from the heated first flowable heat-transfer medium to a third flowable heat-transfer medium, to provide a heated third flowable heat-transfer medium; and transferring heat from the heated third flowable heat-transfer medium to at least one polyamide-containing component of the polyamide synthesis system.

Statement 51 provides the method of Statement 50, wherein the at least one component of the polyamide synthesis system to which heat is transferred from the heated third flowable heat-transfer medium is different than the at least one component of the polyamide synthesis system to which heat is transferred from the heated second flowable heat-transfer medium.

Statement 52 provides a method of making nylon-6,6, the method comprising: heating a first flowable heat-transfer medium comprising a terphenyl, to provide a heated first flowable heat-transfer medium; transferring heat from the heated first flowable heat-transfer medium to a second flowable heat-transfer medium comprising diphenyl oxide and biphenyl, to provide a heated second flowable heat-transfer medium and a used first flowable heat-transfer medium, wherein the first flowable heat-transfer medium, the heated first flowable heat-transfer medium, and the used first flowable heat-transfer medium are disposed in a first heating loop, during the heating of the first flowable heat-transfer medium and transferring of heat from the heated first flowable heat-transfer medium to the second flowable heat-transfer medium, the first flowable heat-transfer medium, the heated first flowable heat-transfer medium, and the used first flowable heat-transfer medium are substantially liquid phase, the heat transferred to the first flowable heat-transfer medium and the heat transferred from the first flowable heat-transfer medium comprise substantially all sensible heat, and during the transferring of heat from the heated first flowable heat-transfer medium to the second flowable heat-transfer medium, the second flowable heat-transfer medium is substantially all vaporized; circulating the used first flowable heat-transfer medium back to the heating of the first flowable heat-transfer medium; transferring heat from the heated second flowable heat-transfer medium to at least one component of a nylon-6,6 synthesis system comprising a preheater, an evaporator, a polymerization reactor, a flasher, a finisher, or an autoclave, providing a used second flowable heat-transfer medium, wherein the second flowable heat-transfer medium and the heated second flowable heat-transfer medium are disposed in a second heating loop, the second flowable heat-transfer medium and the used second flowable heat-transfer medium are substantially liquid phase, the heated second flowable heat-transfer medium is substantially liquid phase, and the heat transferred to the second flowable heat-transfer medium, and the heat transferred from the second flowable heat-transfer medium, comprises about 70-100% latent heat comprising heat of vaporization, and about 0-30% sensible heat; controlling a pressure of the second heat-transfer loop to control a saturation temperature of the second flowable heat-transfer medium, wherein controlling the saturation temperature controls a temperature of the at least one polyamide-containing component of the polyamide synthesis system; and circulating the used second flowable heat-transfer medium back to the transferring of heat from the heated first flowable heat-transfer medium.

Statement 53 provides a system for making a polyamide, the system comprising: a heater configured to heat a first flowable heat-transfer medium to provide a heated first flowable heat-transfer medium; a first heat exchanger configured to transfer heat from the heated first flowable heat-transfer medium to provide a heated second flowable heat-transfer medium; and a second heat exchanger configured to transfer heat from the heated second flowable heat-transfer medium to at least one polyamide-containing component of a polyamide synthesis system.

Statement 54 provides an apparatus for making a polyamide, the apparatus comprising: a heater configured to heat a first flowable heat-transfer medium to provide a heated first flowable heat-transfer medium; a first heat exchanger configured to transfer heat from the heated first flowable heat-transfer medium to provide a heated second flowable heat-transfer medium; and a second heat exchanger configured to transfer heat from the heated second flowable heat-transfer medium to at least one polyamide-containing component of a polyamide synthesis system.

Statement 55 provides the apparatus of Statement 54, wherein the apparatus for making the polyamide is configured to synthesize the polyamide from a linear dicarboxylic acid and a linear diamine or from an oligomer formed from a linear dicarboxylic acid and a linear diamine.

Statement 56 provides the apparatus of Statement 55, wherein the dicarboxylic acid has the structure HOC(O)—R¹—C(O)OH, wherein R¹ is a C₁-C₁₅ alkylene group.

Statement 57 provides the apparatus of Statement 56, wherein the dicarboxylic acid is adipic acid.

Statement 58 provides the apparatus of any one of Statements 55-56, wherein the diamine has the structure H₂N—R²—NH₂, wherein R² is a C₁-C₁₅ alkylene group.

Statement 59 provides the apparatus of Statement 58, wherein the diamine is hexamethylenediamine.

Statement 60 provides the method of any one of Statements 55-59, wherein the polyamide is nylon-6,6.

Statement 61 provides the apparatus of any one of Statements 54-60, wherein the at least one polyamide-containing component of the polyamide synthesis system comprises at least one of a preheater, an evaporator, a polymerization reactor, a flasher, a finisher, and an autoclave.

Statement 62 provides the apparatus of any one of Statements 54-61, wherein at standard temperature and pressure, the first flowable heat-transfer medium has a lower vapor pressure than the second flowable heat-transfer medium.

Statement 63 provides the apparatus of any one of Statements 54-62, wherein the heated second flowable heat-transfer medium has a higher vapor pressure than the heated first flowable heat-transfer medium.

Statement 64 provides the apparatus of any one of Statements 54-63, wherein the heated second flowable heat-transfer medium is at least one of more flammable and more combustible than the heated first flowable heat-transfer medium.

Statement 65 provides the apparatus of any one of Statements 54-64, wherein the first flowable heat-transfer medium comprises at least one of water, a polyethylene glycol, a polypropylene glycol, a mineral oil, a silicone oil, diphenyl oxide, and biphenyl.

Statement 66 provides the apparatus of any one of Statements 54-65, wherein the first flowable heat-transfer medium is at least one of trimethylpentane, a C₁₀₋₁₃ alkane, a C₁₀₋₁₃ iso-alkane, a C₁₄₋₃₀ alkylaryl compound, a diethylbenzene, an ethylenated benzene, a cyclohexylbenzene, a C₁₄₋₃₀ alkyl benzene, white petroleum mineral oil, ethyl diphenyl ethane, diphenyl ethane, diethyl diphenyl ethane, diphenyl ether, diphenyl oxide, ethylbenzene polymer, biphenyl, an inorganic salt, diisopropyl biphenyl, triisopropyl biphenyl, methylcyclohexane, bicyclohexyl, a terphenyl, a hydrogenated terphenyl, a partially hydrogenated quaterphenyls, a partially hydrogenated higher polyphenyl, diphenyl ether, and phenanthrene, a diaryl compound, a triaryl compound, a diaryl ether, a triaryl ether, an alkylaryl compound, an alkylaryl compound, and a diarylalkyl compound.

Statement 67 provides the apparatus of any one of Statements 54-66, wherein the heated first flowable heat-transfer medium is about 280° C. to about 400° C.

Statement 68 provides the apparatus of any one of Statements 54-67, wherein the heated first flowable heat-transfer medium is about 330° C. to about 350° C.

Statement 69 provides the apparatus of any one of Statements 54-68, wherein the first flowable heat-transfer medium and the heated first flowable heat-transfer medium are substantially liquid phase.

Statement 70 provides the apparatus of any one of Statements 54-69, wherein during the heating of the first flowable heat-transfer medium, the first flowable heat-transfer medium substantially remains a liquid.

Statement 71 provides the apparatus of any one of Statements 54-70, wherein during the heating of the first flowable heat-transfer medium, substantially no vaporization of the first flowable heat-transfer medium occurs.

Statement 72 provides the apparatus of any one of Statements 54-71, wherein during the heating of the first flowable heat-transfer medium, the heat transferred to the first flowable heat-transfer medium comprises substantially all sensible heat.

Statement 73 provides the apparatus of any one of Statements 54-72, wherein during the transferring of heat from the heated first flowable heat-transfer medium to the second flowable heat-transfer medium, the heated first flowable heat-transfer medium substantially remains a liquid.

Statement 74 provides the apparatus of any one of Statements 54-73, wherein during the transferring of heat from the heated first flowable heat-transfer medium to the second flowable heat-transfer medium, substantially no condensation of the heated first flowable heat-transfer medium occurs.

Statement 75 provides the apparatus of any one of Statements 54-74, wherein during the transferring of heat from the heated first flowable heat-transfer medium to the second flowable heat-transfer medium, the heat transferred from the heated first flowable heat-transfer medium comprises substantially all sensible heat.

Statement 76 provides the apparatus of any one of Statements 54-75, wherein the first flowable heat-transfer medium and the heated first-flowable heat-transfer medium are disposed in a first heating loop.

Statement 77 provides the apparatus of any one of Statements 54-76, wherein transferring heat from the heated first flowable heat-transfer medium to the second flowable heat-transfer medium provides a used first flowable heat-transfer medium, further comprising circulating the used first flowable heat-transfer medium back to the heating of the first flowable heat-transfer medium.

Statement 78 provides the apparatus of any one of Statements 54-77, wherein the second flowable heat-transfer medium is at least one of water, a polyethylene glycol, a polypropylene glycol, a mineral oil, a silicone oil, diphenyl oxide, biphenyl, and a terphenyl.

Statement 79 provides the apparatus of any one of Statements 54-78, wherein the second flowable heat-transfer medium is at least one of trimethylpentane, a C₁₀₋₁₃ alkane, a C₁₀₋₁₃ iso-alkane, a C₁₄₋₃₀ alkylaryl compound, a diethylbenzene, an ethylenated benzene, a cyclohexylbenzene, a C₁₄₋₃₀ alkyl benzene, white petroleum mineral oil, ethyl diphenyl ethane, diphenyl ethane, diethyl diphenyl ethane, diphenyl ether, diphenyl oxide, ethylbenzene polymer, biphenyl, an inorganic salt, diisopropyl biphenyl, triisopropyl biphenyl, methylcyclohexane, bicyclohexyl, a terphenyl, a hydrogenated terphenyl, a partially hydrogenated quaterphenyls, a partially hydrogenated higher polyphenyl, diphenyl ether, and phenanthrene, a diaryl compound, a triaryl compound, a diaryl ether, a triaryl ether, an alkylaryl compound, an alkylaryl compound, and a diarylalkyl compound.

Statement 80 provides the apparatus of any one of Statements 54-79, wherein the heated second flowable heat-transfer medium is about 210° C. to about 350° C.

Statement 81 provides the apparatus of any one of Statements 54-80, wherein the heated second flowable heat-transfer medium is about 260° C. to about 300° C.

Statement 82 provides the apparatus of any one of Statements 54-81, wherein the heated second flowable heat-transfer medium is substantially liquid phase.

Statement 83 provides the apparatus of any one of Statements 54-82, wherein the heated second flowable heat-transfer medium is substantially gas phase.

Statement 84 provides the apparatus of any one of Statements 54-83, wherein during the transferring of heat from the heated first flowable heat-transfer medium to the second flowable heat-transfer medium, the second flowable heat-transfer medium substantially becomes a gas.

Statement 85 provides the apparatus of any one of Statements 54-84, wherein during the transferring of heat from the heated first flowable heat-transfer medium to the second flowable heat-transfer medium, the second flowable heat-transfer medium is substantially all vaporized.

Statement 86 provides the apparatus of any one of Statements 1-85, wherein the second heat-transfer medium and the heated second heat-transfer medium are disposed in a second heating loop.

Statement 87 provides the apparatus of Statement 86, wherein the second heating loop is configured to control a pressure of the second flowable heat-transfer medium to control a temperature at which the second flowable heat-transfer medium vaporizes.

Statement 88 provides the apparatus of Statement 87, wherein controlling the temperature at which the second flowable heat-transfer medium vaporizes controls a temperature of the at least one polyamide-containing component of the polyamide synthesis system.

Statement 89 provides the apparatus of any one of Statements 54-88, wherein during the transferring of heat from the heated first flowable heat-transfer medium to the second flowable heat-transfer medium, the heat transferred to the second flowable heat-transfer medium comprises substantially all latent heat comprising heat of vaporization.

Statement 90 provides the apparatus of any one of Statements 54-89, wherein during the transferring of heat from the heated first flowable heat-transfer medium to the second flowable heat-transfer medium, the heat transferred to the second flowable heat-transfer medium comprises about 70-100% latent heat comprising heat of vaporization, and about 0-30% sensible heat.

Statement 91 provides the apparatus of any one of Statements 54-90, wherein during the transferring of heat from the heated second flowable heat-transfer medium to the at least one polyamide-containing component of the polyamide synthesis system, the heated second flowable heat-transfer medium substantially condenses into a liquid.

Statement 92 provides the apparatus of any one of Statements 54-91, wherein the second heat-transfer medium and the heated second heat-transfer medium are disposed in a second heating loop.

Statement 93 provides the apparatus of Statement 92, wherein the second heating loop is configured to control a pressure in the second heating loop to adjust a temperature at which the heated second flowable heat-transfer medium undergoes the at least partial condensation.

Statement 94 provides the apparatus of Statement 93, wherein controlling the temperature at which the heated second flowable heat-transfer medium undergoes the at least partial condensation controls the temperature of the at least one polyamide-containing component of the polyamide synthesis system.

Statement 95 provides the apparatus of any one of Statements 93-94, wherein controlling the pressure in the second heating loop comprises controlling the saturation temperature of the heated second flowable heat-transfer medium.

Statement 96 provides the apparatus of Statement 95, wherein a maximum temperature of the heated second flowable heat-transfer medium is within about 0-40° C. of the saturation temperature of the heated second flowable heat-transfer medium.

Statement 97 provides the apparatus of any one of Statements 54-96, wherein during the transferring of heat from the heated second flowable heat-transfer medium to the at least one polyamide-containing component of the polyamide synthesis system, the heat transferred from the heated second flowable heat-transfer medium comprises substantially all latent heat comprising heat of vaporization.

Statement 98 provides the apparatus of any one of Statements 54-97 wherein during the transferring of heat from the heated second flowable heat-transfer medium to the at least one polyamide-containing component of the polyamide synthesis system, the heat transferred from the second flowable heat-transfer medium comprises about 70-100% latent heat comprising heat of vaporization, and about 0-30% sensible heat.

Statement 99 provides the apparatus of any one of Statements 54-98, wherein transferring heat from the heated second flowable heat-transfer medium to the at least one component of the polyamide synthesis system provides a used second flowable heat-transfer medium, further comprising circulating the used second flowable heat-transfer medium back to the transferring of heat from the heated first flowable heat-transfer medium.

Statement 100 provides the apparatus of any one of Statements 54-99, wherein transferring heat from the heated second flowable heat-transfer medium to the at least one component of the polyamide synthesis system comprises maintaining the temperature of the at least one component of the polyamide synthesis system at about 150° C. to about 350° C.

Statement 101 provides the apparatus of any one of Statements 54-100, wherein transferring heat from the heated second flowable heat-transfer medium to the at least one component of the polyamide synthesis system comprises maintaining the temperature of the at least one component of the polyamide synthesis system at about 210° C. to about 260° C.

Statement 102 provides the apparatus of any one of Statements 54-101, wherein transferring heat from the heated second flowable heat-transfer medium to the at least one component of the polyamide synthesis system comprises maintaining the temperature of a polyamide mixture in a reactor at about 218° C. to about 250° C.

Statement 103 provides the apparatus of any one of Statements 54-102, wherein transferring heat from the heated first flowable heat-transfer medium to the second flowable heat-transfer medium provides a used first flowable heat-transfer medium, wherein the second heat exchanger is configured to transfer heat from the used first flowable heat-transfer medium or from the heated first flowable heat-transfer medium to a third flowable heat-transfer medium, to provide a heated third flowable heat-transfer medium, the apparatus further comprising a third heat exchanger configured to transfer heat from the heated third flowable heat-transfer medium to at least one polyamide-containing component of the polyamide synthesis system.

Statement 104 provides the apparatus of Statement 103, wherein the at least one component of the polyamide synthesis system to which heat is transferred from the heated third flowable heat-transfer medium is different than the at least one component of the polyamide synthesis system to which heat is transferred from the heated second flowable heat-transfer medium.

Statement 105 provides a method of making nylon-6,6, the method comprising: a heater configured to heat a first flowable heat-transfer medium comprising a terphenyl, to provide a heated first flowable heat-transfer medium; a first heat exchanger configured to transfer heat from the heated first flowable heat-transfer medium to a second flowable heat-transfer medium comprising diphenyl oxide and biphenyl, to provide a heated second flowable heat-transfer medium and a used first flowable heat-transfer medium, and to circulate the used first flowable heat-transfer medium back to the first heat exchanger, wherein the first flowable heat-transfer medium, the heated first flowable heat-transfer medium, and the used first flowable heat-transfer medium are disposed in a first heating loop, during the heating of the first flowable heat-transfer medium and transferring of heat from the heated first flowable heat-transfer medium to the second flowable heat-transfer medium, the first flowable heat-transfer medium, the heated first flowable heat-transfer medium, and the used first flowable heat-transfer medium are substantially liquid phase, the heat transferred to the first flowable heat-transfer medium and the heat transferred from the first flowable heat-transfer medium comprise substantially all sensible heat, and during the transferring of heat from the heated first flowable heat-transfer medium to the second flowable heat-transfer medium, the second flowable heat-transfer medium is substantially all vaporized; and a second heat exchanger configured to transfer heat from the heated second flowable heat-transfer medium to at least one component of a nylon-6,6 synthesis system comprising a preheater, an evaporator, a polymerization reactor, a flasher, a finisher, or an autoclave, providing a used second flowable heat-transfer medium, and to circulate the used second flowable heat-transfer medium back to the transferring of heat from the heated first flowable heat-transfer medium, wherein the second flowable heat-transfer medium and the heated second flowable heat-transfer medium are disposed in a second heating loop configured to control a saturation temperature of the second flowable heat-transfer medium, wherein controlling the saturation temperature controls a temperature of the at least one polyamide-containing component of the polyamide synthesis system, the second flowable heat-transfer medium and the used second flowable heat-transfer medium are substantially liquid phase, the heated second flowable heat-transfer medium is substantially liquid phase, and the heat transferred to the second flowable heat-transfer medium, and the heat transferred from the second flowable heat-transfer medium, comprises about 70-100% latent heat comprising heat of vaporization, and about 0-30% sensible heat.

Statement 106 provides the apparatus or method of any one or any combination of Statements 1-105 optionally configured such that all elements or options recited are available to use or select from.

1. A method of making a polyamide, the method comprising:
heating a first flowable heat-transfer medium, to provide a heated first flowable heat-transfer medium;
transferring heat from the heated first flowable heat-transfer medium to a second flowable heat-transfer medium, to provide a heated second flowable heat-transfer medium; and
transferring heat from the heated second flowable heat-transfer medium to at least one polyamide-containing component of a polyamide synthesis system.

2. The method of claim 1, wherein the at least one component of the polyamide synthesis system comprises at least one of a preheater, an evaporator, a polymerization reactor, a flasher, a finisher, and an autoclave.

3. The method of claim 1, wherein the first flowable heat-transfer medium comprises at least one of water, a polyethylene glycol, a polypropylene glycol, a mineral oil, a silicone oil, diphenyl oxide, biphenyl, trimethylpentane, a C10-13 alkane, a C10-13 iso-alkane, a C14-30 alkylaryl compound, a diethylbenzene, an ethylenated benzene, a cyclohexylbenzene, a C14-30 alkyl benzene, white petroleum mineral oil, ethyl diphenyl ethane, diphenyl ethane, diethyl diphenyl ethane, diphenyl ether, ethylbenzene polymer, an inorganic salt, diisopropyl biphenyl, triisopropyl biphenyl, methylcyclohexane, bicyclohexyl, a terphenyl, a hydrogenated terphenyl, a partially hydrogenated quaterphenyls, a partially hydrogenated higher polyphenyl, diphenyl ether, and phenanthrene, a diaryl compound, a triaryl compound, a diaryl ether, a triaryl ether, an alkylaryl compound, an alkylaryl compound, and a diarylalkyl compound.

4. The method of claim 1, wherein the first flowable heat-transfer medium and the heated first flowable heat-transfer medium are substantially liquid phase.

5. The method of claim 1, wherein during the heating of the first flowable heat-transfer medium, the heat transferred to the first flowable heat-transfer medium comprises substantially all sensible heat.

6. The method of claim 1, wherein during the transferring of heat from the heated first flowable heat-transfer medium to the second flowable heat-transfer medium, the heat transferred from the heated first flowable heat-transfer medium comprises substantially all sensible heat.

7. The method of claim 1, wherein transferring heat from the heated first flowable heat-transfer medium to the second flowable heat-transfer medium provides a used first flowable heat-transfer medium, further comprising circulating the used first flowable heat-transfer medium back to the heating of the first flowable heat-transfer medium.

8. The method of claim 1, wherein the second flowable heat-transfer medium is at least one of water, a polyethylene glycol, a polypropylene glycol, a mineral oil, a silicone oil, diphenyl oxide, biphenyl, a terphenyl, trimethylpentane, a C10-13 alkane, a C10-13 iso-alkane, a C14-30 alkylaryl compound, a diethylbenzene, an ethylenated benzene, a cyclohexylbenzene, a C14-30 alkyl benzene, white petroleum mineral oil, ethyl diphenyl ethane, diphenyl ethane, diethyl diphenyl ethane, diphenyl ether, ethylbenzene polymer, an inorganic salt, diisopropyl biphenyl, triisopropyl biphenyl, methylcyclohexane, bicyclohexyl, a terphenyl, a hydrogenated terphenyl, a partially hydrogenated quaterphenyls, a partially hydrogenated higher polyphenyl, diphenyl ether, and phenanthrene, a diaryl compound, a triaryl compound, a diaryl ether, a triaryl ether, an alkylaryl compound, an alkylaryl compound, and a diarylalkyl compound.

9. The method of claim 1, wherein during the transferring of heat from the heated first flowable heat-transfer medium to the second flowable heat-transfer medium, the second flowable heat-transfer medium substantially becomes a gas.

10. The method of claim 9, further comprising controlling a pressure of the second flowable heat-transfer medium to control a temperature at which the second flowable heat-transfer medium vaporizes.

11. The method of claim 1, wherein during the transferring of heat from the heated first flowable heat-transfer medium to the second flowable heat-transfer medium, the heat transferred to the second flowable heat-transfer medium comprises about 70-100% latent heat comprising heat of vaporization, and about 0-30% sensible heat.

12. The method of claim 1, wherein during the transferring of heat from the heated second flowable heat-transfer medium to the at least one polyamide-containing component of the polyamide synthesis system, the heated second flowable heat-transfer medium substantially condenses into a liquid.

13. The method of claim 12, further comprising controlling a pressure of the heated second flowable heat-transfer medium to adjust a temperature at which the heated second flowable heat-transfer medium undergoes the at least partial condensation.

14. The method of claim 1, wherein a maximum temperature of the heated second flowable heat-transfer medium is within about 0-40° C. of the saturation temperature of the heated second flowable heat-transfer medium.

15. The method of claim 1, wherein during the transferring of heat from the heated second flowable heat-transfer medium to the at least one polyamide-containing component of the polyamide synthesis system, the heat transferred from the second flowable heat-transfer medium comprises about 70-100% latent heat comprising heat of vaporization, and about 0-30% sensible heat.

16. The method of claim 1, wherein transferring heat from the heated second flowable heat-transfer medium to the at least one component of the polyamide synthesis system provides a used second flowable heat-transfer medium, further comprising circulating the used second flowable heat-transfer medium back to the transferring of heat from the heated first flowable heat-transfer medium.

17. The method of claim 1, wherein transferring heat from the heated second flowable heat-transfer medium to the at least one component of the polyamide synthesis system comprises maintaining the temperature of the at least one component of the polyamide synthesis system at about 150° C. to about 350° C.

18. The method of claim 1, wherein transferring heat from the heated first flowable heat-transfer medium to the second flowable heat-transfer medium provides a used first flowable heat-transfer medium, further comprising
transferring heat from the used first flowable heat-transfer medium or from the heated first flowable heat-transfer medium to a third flowable heat-transfer medium, to provide a heated third flowable heat-transfer medium; and
transferring heat from the heated third flowable heat-transfer medium to at least one polyamide-containing component of the polyamide synthesis system.

19. A method of making nylon-6,6, the method comprising:
heating a first flowable heat-transfer medium comprising a terphenyl, to provide a heated first flowable heat-transfer medium;
transferring heat from the heated first flowable heat-transfer medium to a second flowable heat-transfer medium comprising diphenyl oxide and biphenyl, to provide a heated second flowable heat-transfer medium and a used first flowable heat-transfer medium, wherein
the first flowable heat-transfer medium, the heated first flowable heat-transfer medium, and the used first flowable heat-transfer medium are disposed in a first heating loop,
during the heating of the first flowable heat-transfer medium and transferring of heat from the heated first flowable heat-transfer medium to the second flowable heat-transfer medium, the first flowable heat-transfer medium, the heated first flowable heat-transfer medium, and the used first flowable heat-transfer medium are substantially liquid phase,
the heat transferred to the first flowable heat-transfer medium and the heat transferred from the first flowable heat-transfer medium comprise substantially all sensible heat, and
during the transferring of heat from the heated first flowable heat-transfer medium to the second flowable heat-transfer medium, the second flowable heat-transfer medium is substantially all vaporized;
circulating the used first flowable heat-transfer medium back to the heating of the first flowable heat-transfer medium;
transferring heat from the heated second flowable heat-transfer medium to at least one component of a nylon-6,6 synthesis system comprising a preheater, an evaporator, a polymerization reactor, a flasher, a finisher, or an autoclave, providing a used second flowable heat-transfer medium, wherein
the second flowable heat-transfer medium and the heated second flowable heat-transfer medium are disposed in a second heating loop,
the second flowable heat-transfer medium and the used second flowable heat-transfer medium are substantially liquid phase,
the heated second flowable heat-transfer medium is substantially liquid phase, and
the heat transferred to the second flowable heat-transfer medium, and the heat transferred from the second flowable heat-transfer medium, comprises about 70-100% latent heat comprising heat of vaporization, and about 0-30% sensible heat;
controlling a pressure of the second heat-transfer loop to control a saturation temperature of the second flowable heat-transfer medium, wherein controlling the saturation temperature controls a temperature of the at least one polyamide-containing component of the polyamide synthesis system; and
circulating the used second flowable heat-transfer medium back to the transferring of heat from the heated first flowable heat-transfer medium.

20. A system for making a polyamide, the system comprising:
a heater configured to heat a first flowable heat-transfer medium to provide a heated first flowable heat-transfer medium;
a first heat exchanger configured to transfer heat from the heated first flowable heat-transfer medium to provide a heated second flowable heat-transfer medium; and
a second heat exchanger configured to transfer heat from the heated second flowable heat-transfer medium to at least one polyamide-containing component of a polyamide synthesis system.
